(19) United States
(12) Patent Application Publication
(10) Pub. No.: US 2004/0161196 A1
(43) Pub. Date: Aug. 19, 2004

(54) Diffraction grating device making method and apparatus

(75) Inventors: Kiyotaka Murashima, Yokohama-shi (JP); Ken Hashimoto, Yokohama-shi (JP); Toshikazu Shibata, Yokohama-shi (JP); Toru Iwashima, Yokohama-shi (JP); Akira Inoue, Yokohama-shi (JP)

Correspondence Address: MCDERMOTT WILL & EMERY LLP, 600 13TH STREET, N.W., WASHINGTON, DC, 20005-3096, US

(73) Assignee: SUMITOMO ELECTRIC INDUSTRIES, LTD.

(21) Appl. No.: 10/756,831

(22) Filed: Jan. 14, 2004

(30) Foreign Application Priority Data
Jan. 14, 2003 (JP) P2003-006146

(51) Int. Cl. G02B 6/34

(52) U.S. Cl. 385/37

(57) ABSTRACT

Refractive index change inducing light UV outputted from a light source passes a shutter and an optical system, and then is reflected by a mirror, so as to irradiate an optical fiber by way of a phase grating mask. A diffracting action of the phase grating mask generates a (+)first-order light component and a (−)first-order light component, which interfere with each other, thereby generating interference fringes with a fringe interval Λ. As the mirror moves along the z axis, an irradiation position at which the optical fiber is irradiated with the refractive index change inducing light UV by way of the phase grating mask is scanned. While moving the mirror upon irradiation with the refractive index change inducing light UV, the phase grating mask is vibrated along the z axis under the action of a piezoelectric device. The phase or period of vibration varies from scan to scan.

### BACKGROUND OF THE INVENTION

1. Field of the Invention

The present invention relates to a method and apparatus for making a diffraction grating device in which a diffraction grating is formed by refractive index modulation over a predetermined area in an optical waveguide along its longitudinal direction.

2. Related Background Art

A diffraction grating device comprises an optical waveguide (e.g., optical fiber) having a diffraction grating formed over a predetermined area along its longitudinal direction. By using the diffraction grating, the diffraction grating device can selectively reflect a light component having a predetermined reflection wavelength in light propagating through the optical waveguide. Multi/demultiplexers including the diffraction grating device can multiplex or demultiplex light by selectively reflecting a light component having a predetermined reflection wavelength with the diffraction grating device, and are used in wavelength division multiplexing (WDM) transmission systems for carrying out optical transmission by using wavelength-multiplexed signal light having a plurality of wavelengths, and the like.

In general, a diffraction grating device comprises an optical waveguide having a diffraction grating formed by refractive index modulation with a predetermined period Λ over a predetermined area in its longitudinal direction. The diffraction grating selectively reflects a light component having a reflection wavelength λ satisfying the Bragg condition represented by the expression of λ=2n₀Λ, and transmits the other wavelength light components therethrough. Here, n₀ is the average effective refractive index in the refractive index modulated region in the optical waveguide.

Such a diffraction grating device can be made by a phase grating method. See, for example, Document 1: K. O. Hill, et al., “Bragg gratings fabricated in monomode photosensitive optical fiber by UV exposure through a phase mask”, Appl. Phys. Lett., Vol. 62, No. 10, pp. 1035-1037 (1993). In this method, an optical waveguide which is photosensitive to light in a certain wavelength region, and a phase grating mask comprising a transparent plate having one surface formed with a phase grating are prepared. By way of the phase grating mask arranged beside the optical waveguide, the optical waveguide is irradiated with refractive index change inducing light. At that moment, the refractive index change inducing light incident on the phase grating mask is diffracted by the phase grating, so as to generate (+)first- and (−)first-order light components, which form interference fringes therebetween. According to spatial intensity modulation of the refractive index change inducing light in the interference fringes, a diffraction grating is formed in the photosensitive optical waveguide by spatial refractive index modulation. This makes a diffraction grating device.

### SUMMARY OF THE INVENTION

In such a diffraction grating device, the amplitude distribution of refractive index modulation in the refractive index modulated region may be either constant or variable in the longitudinal direction. Varying the amplitude distribution of refractive index modulation in the longitudinal direction improves reflection characteristics of the diffraction grating device. When the amplitude distribution of refractive index modulation has a phase inverting part, reflection characteristics of the diffraction grating device further improve.

Though some literatures have proposed structures of diffraction grating devices having an amplitude distribution of refractive index modulation with a phase inverting part and set forth simulations of reflection characteristics thereof, neither methods nor apparatus for making them have been disclosed yet.

In order to overcome the problem mentioned above, it is an object of the present invention to provide a diffraction grating making method and apparatus which can easily make a diffraction grating device even when the amplitude distribution of refractive index modulation is not constant (and also when the amplitude distribution of refractive index modulation has a phase inverting part).

The present invention provides a method for making a diffraction grating device having a diffraction grating formed by refractive index modulation over a predetermined area in an optical waveguide along a longitudinal direction thereof; the method comprising the steps of disposing a phase grating mask beside the optical waveguide; irradiating the optical waveguide with refractive index change inducing light by way of the phase grating mask while repeatedly scanning an irradiation point of the refractive index change inducing light in the longitudinal direction; vibrating the phase grating mask in the longitudinal direction relative to the optical waveguide upon irradiation with the refractive index change inducing light; and changing a phase or period of vibration of the phase grating mask for each scan of the irradiation point of the refractive index change inducing light, so as to form a diffraction grating in the optical waveguide.

The present invention provides an apparatus for making a diffraction grating device having a diffraction grating formed by refractive index modulation over a predetermined area in an optical waveguide along a longitudinal direction thereof; the apparatus comprising (1) refractive index change inducing light irradiating means for irradiating the optical waveguide with refractive index change inducing light by way of a phase grating mask disposed beside the optical waveguide, and repeatedly scanning an irradiation position of the refractive index change inducing light in the longitudinal direction; and (2) phase grating mask vibrating means for vibrating the phase grating mask in the longitudinal direction relative to the optical waveguide upon irradiation with the refractive index change inducing light, and changing a phase or period of vibration of the phase grating mask for each scan of the irradiation point of the refractive index change inducing light.

In the method or apparatus in accordance with these aspects of the present invention, a phase grating mask is disposed beside an optical waveguide (e.g., a silica type optical fiber having a core region doped with GeO₂) and is vibrated in the longitudinal direction relative to the optical waveguide. The optical waveguide is irradiated with refractive index change inducing light (e.g., ultraviolet light) by way of the vibrating phase grating mask. According to intensity patterns of interference fringes generated upon the irradiation, refractive index modulation is caused in the optical waveguide, which forms a diffraction grating, thereby making a diffraction grating device. The amplitude of thus formed refractive index modulation conforms to the waveform (shape, amplitude, duty cycle, etc.) of relative vibration of the phase grating mask with respect to the optical waveguide. In particular, the irradiation position of the refractive index change inducing light is repeatedly scanned in the longitudinal direction while the phase or period of vibration of the phase grating mask changes for each scan in these aspects of the present invention. As such, a diffraction grating device having desirable reflection characteristics can be made easily.

Preferably, in the method in accordance with the present invention, the irradiation position of the refractive index change inducing light is scanned N times (where N is an integer of 2 or greater) while the phase of vibration of the phase grating mask is shifted by 2π/N for each scan. Preferably, in the apparatus in accordance with the present invention, the refractive index change inducing light irradiating means scans the irradiation position of the refractive index change inducing light N times (where N is an integer of 2 or greater), and the phase grating mask vibrating means shifts the phase of vibration of the phase grating mask by 2π/N for each scan. Preferably, in the method in accordance with the present invention, N is a power of 2. This case is more preferable when making a diffraction grating device having desirable reflection characteristics.

The present invention provides a method for making a diffraction grating device having a diffraction grating formed by refractive index modulation over a predetermined area in an optical waveguide along a longitudinal direction thereof; the method comprising the steps of disposing a phase grating mask beside the optical waveguide; irradiating the optical waveguide with refractive index change inducing light by way of the phase grating mask while scanning an irradiation point of the refractive index change inducing light in the longitudinal direction; vibrating the phase grating mask in the longitudinal direction relative to the optical waveguide upon irradiation with the refractive index change inducing light; and changing a phase or period of vibration of the phase grating mask upon scanning the irradiation point of the refractive index change inducing light, so as to form a diffraction grating in the optical waveguide.

The present invention provides an apparatus for making a diffraction grating device having a diffraction grating formed by refractive index modulation over a predetermined area in an optical waveguide along a longitudinal direction thereof; the apparatus comprising (1) refractive index change inducing light irradiating means for irradiating the optical waveguide with refractive index change inducing light by way of a phase grating mask disposed beside the optical waveguide, and scanning an irradiation position of the refractive index change inducing light in the longitudinal direction; and (2) phase grating mask vibrating means for vibrating the phase grating mask in the longitudinal direction relative to the optical waveguide upon irradiation with the refractive index change inducing light, and changing a phase or period of vibration of the phase grating mask upon scanning the irradiation point of the refractive index change inducing light.

In the method or apparatus in accordance with these aspects of the present invention, a phase grating mask is disposed beside an optical waveguide (e.g., a silica type optical fiber having a core region doped with GeO₂) and is vibrated in the longitudinal direction relative to the optical waveguide. The optical waveguide is irradiated with refractive index change inducing light (e.g., ultraviolet light) by way of the vibrating phase grating mask. According to intensity patterns of interference fringes generated upon the irradiation, refractive index modulation is caused in the optical waveguide, which forms a diffraction grating, thereby making a diffraction grating device. The amplitude of thus formed refractive index modulation conforms to the waveform (shape, amplitude, duty cycle, etc.) of relative vibration of the phase grating mask with respect to the optical waveguide. In particular, the irradiation position of the refractive index change inducing light is scanned in the longitudinal direction while the period of vibration of the phase grating mask changes upon scanning in these aspects of the present invention. As such, a diffraction grating device having desirable reflection characteristics can be made easily.

The present invention provides a diffraction grating device made by the method in accordance with the above-mentioned aspects of the present invention. This diffraction grating device has an amplitude distribution of refractive index appropriately designed along its longitudinal direction. For example, the amplitude distribution of refractive index modulation has a phase inverting part. This allows the diffraction grating device to reflect light having a plurality of wavelengths selectively or suppress its chromatic dispersion, for example.

The present invention provides a multi/demultiplexing module including the diffraction grating device in accordance with the present invention, the diffraction grating device selectively reflecting a light component having a reflection wavelength, so as to multiplex or demultiplex light. The present invention provides an optical transmission system for carrying out optical transmission by using wavelength-multiplexed signal light having a plurality of wavelengths, the optical transmission system including the multi/demultiplexing module in accordance with the present invention, the multi/demultiplexing module multiplexing or demultiplexing the signal light having a plurality of wavelengths.

The present invention will become more fully understood from the detailed description given hereinbelow and the accompanying drawings. They are given by way of illustration only, and thus should not be considered limitative of the present invention.

### BRIEF DESCRIPTION OF THE DRAWINGS

FIG. 1 is an explanatory view of the diffraction grating device in accordance with an embodiment;

FIG. 2 is an explanatory view of the diffraction grating device making apparatus in accordance with the embodiment;

FIGS. 3A to 3D are explanatory views of a first mode of vibration of a phase grating mask in the diffraction grating device making apparatus in accordance with the embodiment;

FIGS. 4A to 4C are explanatory views of a second mode of vibration of the phase grating mask in the diffraction grating device making apparatus in accordance with the embodiment;

FIG. 5 is an explanatory view of a third mode of vibration of the phase grating mask in the diffraction grating device making apparatus in accordance with the embodiment;

FIG. 6 is a graph showing the relationship between the vibration amplitude a of the phase grating mask and the refractive index modulation amplitude F;

FIGS. 7A and 7B are graphs showing respective distributions of the vibration amplitude a of the phase grating mask and refractive index modulation amplitude F at each position z; FIGS. 8A to 8C are charts for explaining states of vibration of the phase grating mask and opening/closing of a shutter;

FIGS. 9A to 9C are charts for explaining other examples of vibration of the phase grating mask;

FIG. 10 is a chart showing designed target refractive index modulation amplitude distribution F(z) and vibration amplitude a(z) of the phase grating mask;

FIG. 11 is a chart showing a designed refractive index modulation amplitude (solid line) and a refractive index modulation amplitude obtained at a luminous flux width 2w of 3 mm (broken line);

FIG. 12 is a chart showing a designed refractive index modulation amplitude (solid line) and a refractive index modulation amplitude obtained at a luminous flux width 2w of 2 mm (broken line);

FIG. 13 is a chart showing a designed refractive index modulation amplitude (solid line) and a refractive index modulation amplitude obtained at a luminous flux width 2w of 1 mm (broken line);

FIG. 14 is a chart showing a designed refractive index modulation amplitude (solid line) and a refractive index modulation amplitude obtained at a luminous flux width 2w of 0.5 mm (broken line);

FIG. 15 is a chart showing a designed target refractive index modulation amplitude (solid line), a vibration amplitude obtained according to expression (9) (broken line), and a vibration amplitude obtained without regard to expression (9) (dotted line);

FIG. 16 is a chart showing a refractive index modulation amplitude realized when the phase grating mask is vibrated in conformity to the vibration amplitude obtained according to expression (9);

FIG. 17 is a graph showing the relationship between the duty cycle of vibration of the phase grating mask and the refractive index modulation amplitude;

FIGS. 18A and 18B are graphs showing respective distributions of the duty cycle of vibration of the phase grating mask and refractive index modulation amplitude at each position z;

FIGS. 19A and 19B are charts showing the refractive index modulation in each of diffraction grating devices in accordance with examples and comparative examples;

FIGS. 20A and 20B are charts showing reflection and transmission characteristics of the diffraction grating device in accordance with a first comparative example;

FIGS. 21A and 21B are charts showing reflection and transmission characteristics of the diffraction grating device in accordance with a second comparative example;

FIGS. 22A and 22B are charts showing reflection and transmission characteristics of the diffraction grating device in accordance with a third comparative example;

FIGS. 23A and 23B are charts showing reflection and transmission characteristics of the diffraction grating device in accordance with a first example;

FIGS. 24A and 24B are charts showing reflection and transmission characteristics of the diffraction grating device in accordance with a second example;

FIGS. 25A to 25C are respective charts showing reflection characteristics of the diffraction grating devices in accordance with the second comparative example and first and second examples;

FIGS. 26A and 26B are respective charts showing reflection characteristics of the diffraction grating devices in accordance with a fourth comparative example and a third example;

FIG. 27 is an explanatory view of the multi/demultiplexing module in accordance with a first embodiment;

FIG. 28 is an explanatory view of the multi/demultiplexing module in accordance with a second embodiment;

FIG. 29 is an explanatory view of the multi/demultiplexing module in accordance with a third embodiment; and

FIG. 30 is a schematic diagram of the optical transmission system in accordance with an embodiment.

### DETAILED DESCRIPTION OF THE PREFERRED EMBODIMENTS

In the following, embodiments of the present invention will be explained in detail with reference to the accompanying drawings. In the explanation of the drawings, constituents identical to each other will be referred to with numerals identical to each other without repeating their overlapping descriptions.

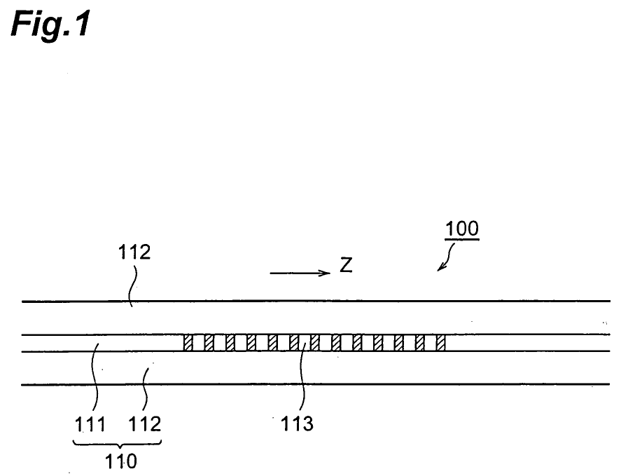

First, an embodiment of the diffraction grating device in accordance with the present invention will be explained. FIG. 1 is an explanatory view of the diffraction grating device 100 in accordance with this embodiment. This drawing is a sectional view of the diffraction grating device 100 taken along a plane including the optical axis. The diffraction grating device 100 comprises an optical fiber 110, which is an optical waveguide, and a diffraction grating 113 formed therein. The optical fiber 110, which is mainly composed of silica glass, comprises a core region 111, doped with GeO₂, including the optical axis center and a cladding region 112 surrounding the core region 111. The optical fiber 110 has a predetermined area (hereinafter referred to as “refractive index modulation forming area”) formed with the diffraction grating 113 by refractive index modulation along its longitudinal direction.

The z axis is set along the longitudinal direction of the optical fiber 110, whereas the origin of the z axis is defined as the center position of the refractive index modulation forming area. The grating spacing of refractive index modulation formed in the refractive index modulation forming area is at a fixed value Λ. In the refractive index modulation forming area, the refractive index distribution n(z) of the diffraction grating 113 is represented by the expression of

$$n ( z ) = {n}_{0} + F ( z ) \cdot cos ( \frac{2 π}{Λ} z ) . \qquad ( 1 )$$

Here, n₀ is the average effective refractive index of the optical fiber 110 in the refractive index modulation forming area. F(z) is the amplitude distribution of refractive index modulation in the refractive index modulation forming area, and is a sinc or cos function, for example. The diffraction grating 100 can selectively reflect light having a reflection wavelength λ (=2n₀Λ) by using the diffraction grating 113. By optimizing the refractive index modulation amplitude distribution F(z), the diffraction grating device 100 can suppress chromatic dispersion, attain a fixed chromatic dispersion, or selectively reflect signal light having a plurality of wavelengths.

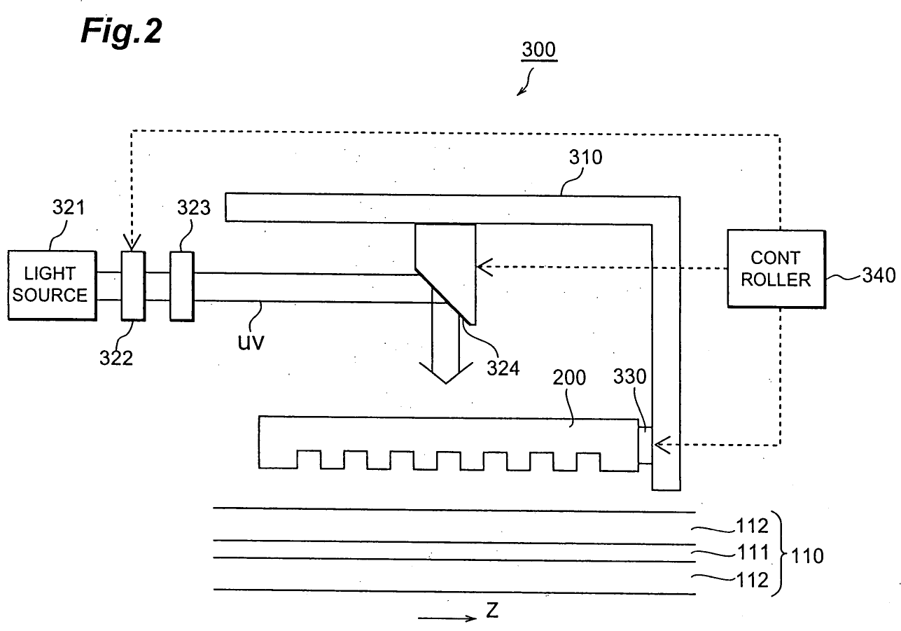

An embodiment of the diffraction grating device making apparatus in accordance with the present invention will now be explained. FIG. 2 is an explanatory view of the diffraction grating device making apparatus 300 in accordance with this embodiment. The diffraction grating device making apparatus 300 is favorably used with a phase grating mask 200 when making the diffraction grating device 100.

The diffraction grating device making apparatus 300 comprises a securing member 310, a light source 321, a shutter 322, an optical system 323, a mirror 324, a piezoelectric device 330, and a controller 340. Among them, the light source 321, shutter 322, optical system 323, and mirror 324 constitute refractive index change inducing light irradiating means for irradiating the optical fiber 110 with refractive index change inducing light by way of the phase grating mask 200. The piezoelectric device 330 constitutes phase grating mask vibrating means for vibrating the phase grating mask 200, disposed beside the optical fiber 110, in z-axis directions relative to the optical fiber 110.

The light source 321 outputs refractive index change inducing light UV which induces a refractive index change in the core region 111 of the optical fiber 110. For example, a KrF excimer laser light source, which outputs laser light having a wavelength of 248 nm as the refractive index change inducing light UV, is favorably used as the light source 321. The shutter 322 is disposed between the light source 321 and the mirror 324, and selectively passes and blocks the refractive index change inducing light UV outputted from the light source 321. An acousto-optic device is preferably used as the shutter 322, whereby switching between the passing and blocking of the refractive index change inducing light UV is carried out rapidly.

The optical system 323 is disposed between the shutter 322 and the mirror 324, and is used in order for the refractive index change inducing light UV to have a luminous flux width of a predetermined value (preferably 500 μm or less, more preferably 100 μm or less) along the z axis when the optical fiber 110 is irradiated with the refractive index change inducing light UV. As the optical system 323, a condenser lens or an aperture having a predetermined aperture width is employed preferably. When the condenser lens is used as the optical system 323, the energy of the refractive index change inducing light UV is effectively utilized, whereby the efficiency in making the diffraction grating becomes better. When an aperture is used as the optical system 323, mechanical damages to the optical fiber 110 are reduced.

The mirror 324 has a reflecting surface inclined by 45 degrees with respect to the z axis, and thus reflects the refractive index change inducing light UV, which has advanced along the z axis by way of the optical system 323, into a direction perpendicular to the z axis. The mirror 324 irradiates the optical fiber 110 with thus reflected refractive index change inducing light UV by way of the phase grating mask 200. The mirror 324 is attached to the securing member 310 so as to be movable in z-axis directions.

The phase grating mask 200 comprises a silica glass plate having one surface formed with a phase grating having a grating space of 2Λ, and is arranged such that the surface formed with the phase grating opposes the optical fiber 110. The grating spacing of the phase grating mask 200 is twice the grating spacing Λ of the diffraction grating 113 to be formed in the optical fiber 110. The phase grating mask 200 is fixed to the securing member 310 by way of the piezoelectric device 330, and can vibrate in z-axis directions under the action of the piezoelectric device 330.

The controller 340 moves the mirror 324 in z-axis directions relative to the securing member 310. As a consequence, over a predetermined area (refractive index modulation forming area) of the optical fiber 110, the controller 340 scans an irradiation position at which the optical fiber 110 is irradiated with the refractive index change inducing light UV. Here, it is preferred that the controller 340 scan the irradiation position of the refractive index change inducing light UV at a fixed rate. In this case, the optical fiber 110 attains a longitudinally uniform average effective refractive index in the refractive index modulation forming area.

The controller 340 regulates the piezoelectric device 330 such that the phase grating mask 200 vibrates in z directions relative to the optical fiber 110. This adjusts the amplitude of refractive index modulation formed in the optical fiber 110. In particular, it is preferred that the controller 340 regulate the waveform of vibration of the phase grating mask 200 according to the irradiation position z of the refractive index change inducing light UV. In this case, at each position z, the amplitude F(z) of refractive index modulation conforms to the waveform of vibration of the phase grating mask 200. This makes the diffraction grating device 100 having desirable optical characteristics.

Preferably, at a given position z₀ within a predetermined area of the optical fiber 110, the controller 340 causes the phase grating mask 200 to attain vibration with a square waveform whose amplitude is ¼ of the grating spacing Λ of the diffraction grating 113 to be formed in the optical fiber 110. In this case, the amplitude distribution function F(z) of refractive index modulation has a phase inverting part at the position z₀, whereby the diffraction grating device 100 achieves better optical characteristics.

Preferably, the controller 340 regulates the phase grating mask 200 such that its vibration attains any of waveforms of square, triangle, sinusoidal, and trapezoidal waves. When the vibration of the phase grating mask 200 has a fixed waveform as such, the amplitude F(z) of refractive index modulation conforms to the amplitude of vibration of the phase grating mask 200 at each position z. Namely, regulating the amplitude of vibration of the phase grating mask 200 according to the position z adjusts the amplitude F(z) of refractive index modulation.

The controller 340 may cause the vibration of the phase grating mask 200 to attain an arbitrary waveform. In this case, it is preferred that the controller 340 shut the shutter 322 during transitional periods of movement of the phase grating mask 200 when vibrating the phase grating mask 200, so that the optical fiber 110 is not irradiated with the refractive index change inducing light UV. This adjusts the amplitude F(z) of refractive index modulation accurately.

Even when the controller 340 regulates the phase grating mask 200 such that its vibration becomes a square wave, it takes a certain fixed time for the phase grating mask 200 to shift from one end to the other end in practice. Therefore, it is preferred for the controller 340 to set a period of the vibration of the phase grating mask 200 such that it is at least 20 times the time actually required for the phase grating mask 200 to shift from one end to the other end. This adjusts the amplitude F(z) of refractive index modulation accurately.

In particular, in this embodiment, the controller 340 moves the mirror 324 back and forth along the z axis, so as to scan the irradiation point of the refractive index change inducing light UV repeatedly in the longitudinal direction, and regulates the piezoelectric device 330, so as to change the phase or period of vibration of the phase grating mask 200 for each scan. Here, it is preferred that the irradiation point of the refractive index change inducing light UV be scanned N times (where N is an integer of 2 or greater), and the phase of vibration of the phase grating mask 200 be shifted by 2π/N for each scan. Preferably, N is a power of 2, i.e., 2′ (where n is a positive integer). Alternatively, the controller 340 moves the mirror 324 in a z-axis direction, so as to scan the irradiation point of the refractive index change inducing light UV in the longitudinal direction, and regulates the piezoelectric device 330, so as to change the period of vibration of the phase grating mask 200 upon scanning. When changing the phase or period of vibration of the phase grating mask 200 as such, the amplitude of vibration of the phase grating mask 200 is set such that a desirable refractive index modulation amplitude distribution function F(z) is obtained. Thus, the diffraction grating device 100 having desirable reflection characteristics can easily be made.

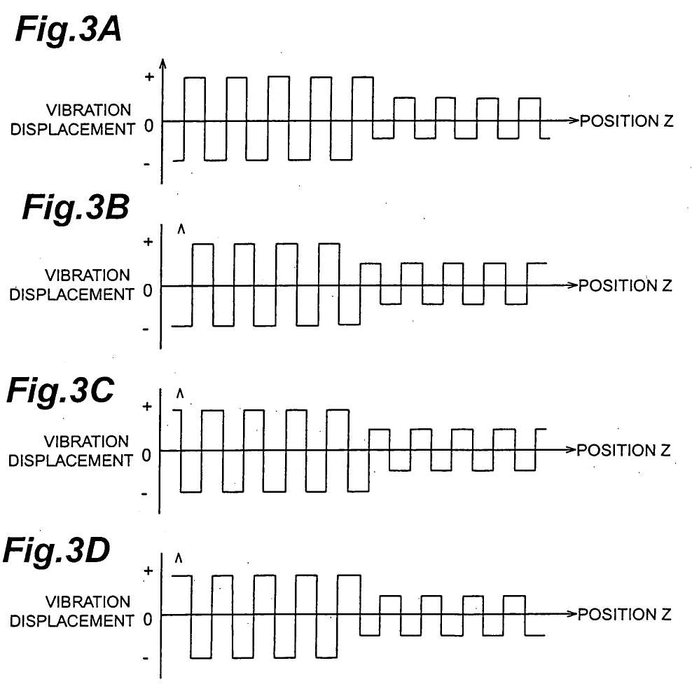

FIGS. 3A to 3D are explanatory views of a first mode of vibration of the phase grating mask 200 in the diffraction grating device making apparatus 300 in accordance with this embodiment. In each of these charts, the abscissa indicates the irradiation position z of the refractive index change inducing light UV, whereas the ordinate indicates the displacement of vibration of the phase grating mask 200. FIGS. 3A to 3D show respective scans of the irradiation point of the refractive index change inducing light UV. In the mode of vibration of the phase grating mask 200 shown in these charts, the irradiation position of the refractive index change inducing light UV is scanned four times, whereas the phase of vibration of the phase grating mask 200 shifts by π/2 for each scan. Namely, the phase of vibration of the phase grating mask 200 in the second scan (FIG. 3B) differs from that of the first scan (FIG. 3A) by π/2. The phase of vibration of the phase grating mask 200 in the third scan (FIG. 3C) differs from that of the second scan (FIG. 3B) by π/2. The phase of vibration of the phase grating mask 200 in the fourth scan (FIG. 3D) differs from that of the third scan (FIG. 3C) by π/2.

Alternatively, after an initial scan (FIG. 3A), a scan (FIG. 3C) for shifting the phase of vibration by n with reference to the initial scan is carried out, and then a scan (FIG. 3B) for shifting the phase of vibration by π/2 and a scan (FIG. 3D) for shifting the phase of vibration by 3π/2 are carried out in succession. Subsequently, respective scans for shifting the phase of vibration by π/4, 5π/4, 3π/4, and 7π/4 may be carried out in succession. This can make the diffraction grating device 100 having desirable reflection characteristics even if the repetitive scanning is incompletely terminated (e.g., after the second scan).

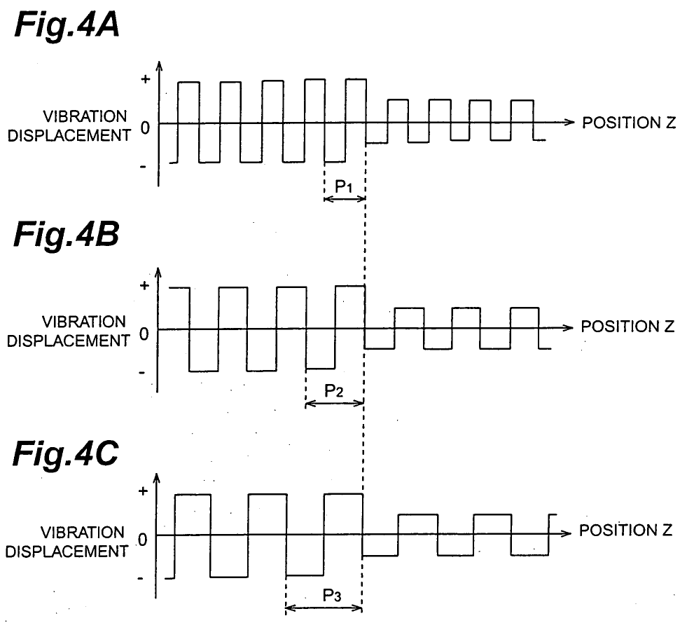

FIGS. 4A to 4C are explanatory views of a second mode of vibration of the phase grating mask 200 in the diffraction grating device making apparatus 300 in accordance with this embodiment. In each of these charts, the abscissa indicates the irradiation position z of the refractive index change inducing light UV, whereas the ordinate indicates the displacement of vibration of the phase grating mask 200. FIGS. 4A to 4C show respective scans of the irradiation position of the refractive index change inducing light UV. In the mode of vibration of the phase grating mask 200 shown in these charts, the irradiation position of the refractive index change inducing light UV is scanned three times, whereas the period of vibration of the phase grating mask 200 varies from scan to scan. Namely, the first scan (FIG. 4A), second scan (FIG. 4B), and third scan (FIG. 4C) have respective periods P₁, P₂, and P₃ of vibration which differ from each other.

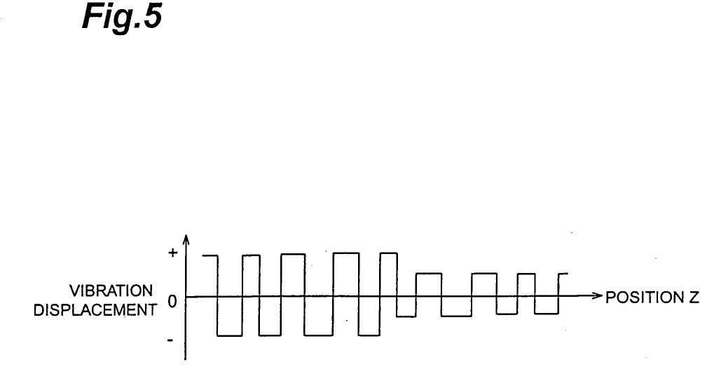

FIG. 5 is an explanatory view of a third mode of vibration of the phase grating mask 200 in the diffraction grating device making apparatus 300 in accordance with this embodiment. The abscissa and ordinate indicate the irradiation position z of the refractive index change inducing light UV and the displacement of vibration of the phase grating mask 200, respectively, in this chart as well. In the mode of vibration of the phase grating mask 200 shown in this chart, the irradiation position of the refractive index change inducing light UV is scanned in the longitudinal direction, while the period of vibration of the phase grating mask 200 varies upon scanning.

Operations of the diffraction grating device making apparatus 300 in accordance with this embodiment will now be explained together with the diffraction grating device making method in accordance with the embodiment. Under the control of the controller 340, the diffraction grating device making apparatus 300 operates as follows:

The refractive index modulation inducing light UV outputted from the light source 321 is made incident on the mirror 324 by way of the shutter 322 and optical system 323, and then is reflected by the mirror 324, so as to irradiate the optical fiber 110 by way of the phase grating mask 200. At that time, the diffracting action of the phase grating mask 200 having a grating spacing 2Λ generates (+) and (−)first-order light components, which interfere with each other, thereby generating interference fringes with a fringe spacing Λ. Also, as the mirror 324 moves over a predetermined area in the z-axis direction, the position at which the optical fiber 110 is irradiated with the refractive index modulation inducing light UV by way of the phase grating mask 200 is scanned. Then, the core region 111 of the optical fiber 110 is formed with a refractive index modulation having a grating spacing Λ according to the spatial distribution of optical energy in thus formed interference fringes, whereby the diffraction grating 113 is formed.

Upon movement of the mirror 324 and irradiation with the refractive index modulation inducing light UV, the phase grating mask 200 is vibrated in the z-axis direction by an action of the piezoelectric device 330. Suppose that the phase grating mask 200 having a grating spacing 2Λ is vibrating in the z-axis direction with respect to the optical fiber 110 whereas the waveform of vibration is a square wave whose probability of existence is ½ each at positions (z+a) and (z−a) where z is the center position of vibration.

Then, the refractive index distribution n(z) of the diffraction grating 113 formed upon irradiation with the refractive index modulation inducing light UV is represented by the following expression (2):

$$\begin{matrix}n ( z ) = {n}_{0} + \frac{1}{2} Δ {n}_{0} [ cos ( \frac{2 π}{Λ} ( z - a ) ) + cos ( \frac{2 π}{Λ} ( z + a ) ) ] \\ = {n}_{0} + Δ {n}_{0} \cdot cos ( \frac{2 π}{Λ} a ) \cdot cos ( \frac{2 π}{Λ} z )\end{matrix} \qquad ( 2 )$$

whereas the amplitude F(z) of refractive index modulation is represented by the following expression (3):

$$F ( z ) = Δ {n}_{0} \cdot cos ( \frac{2 π}{Λ} a ) \qquad ( 3 )$$

where a is the vibration amplitude of the phase grating mask 200, and Δn₀ is the coefficient of value corresponding to the irradiation amount (=irradiation intensity×irradiation time) of refractive index modulation inducing light UV.

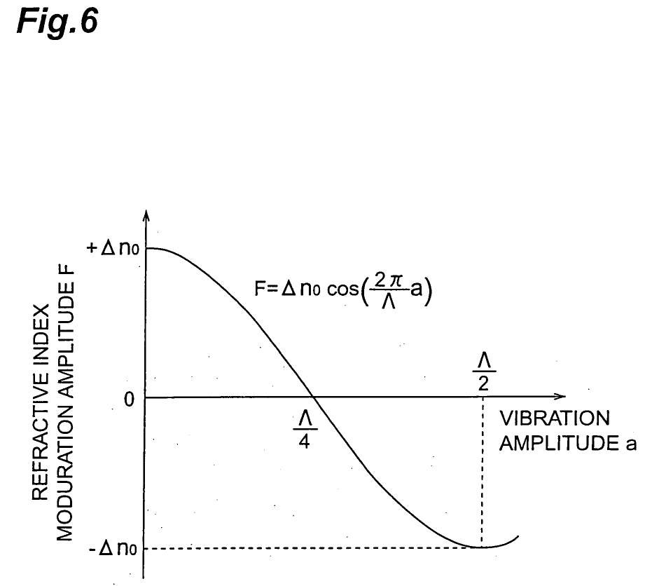

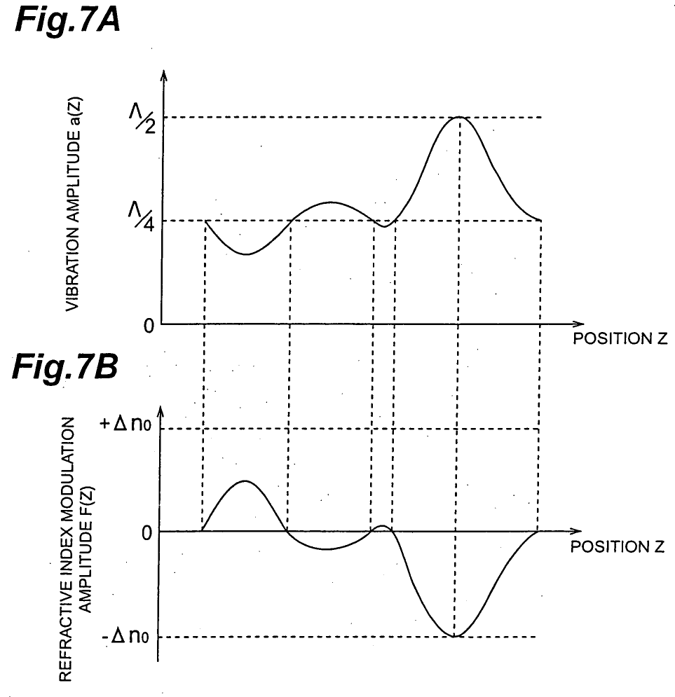

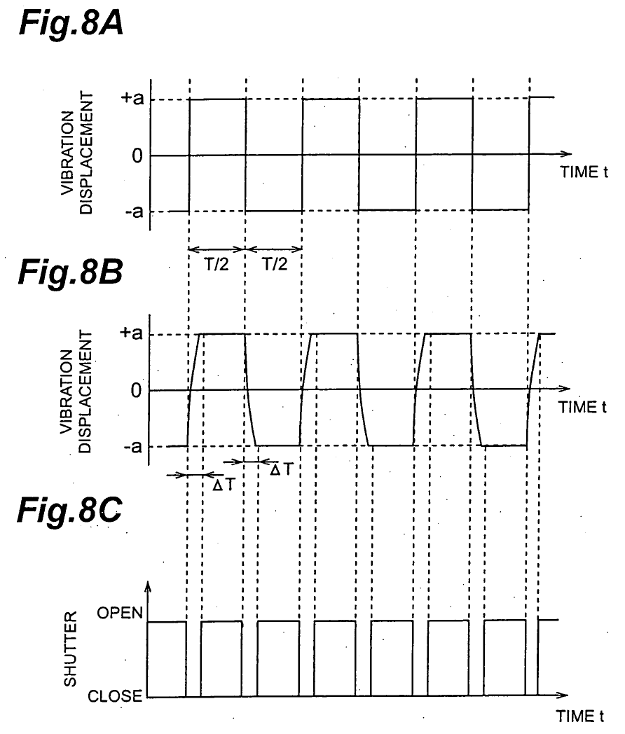

The third factor (cos(2πz/Λ)) in the second term of the right side in the above-mentioned expression (2) indicates that the grating spacing in the diffraction grating 113 is Λ. As shown in FIG. 6, the refractive index modulation inducing light F(z) in the above-mentioned expression (3) is a function of the vibration amplitude a of the phase grating mask 200, and becomes a value corresponding to the amplitude a. Therefore, the refractive index modulation amplitude F(z) can be adjusted when the vibration amplitude a of the phase grating mask 200 is controlled appropriately. Hence, for attaining the refractive index modulation amplitude F(z) shown in FIG. 7B, it will be sufficient if the vibration amplitude a(z) of the phase grating mask 200 at each position z is regulated as shown in FIG. 7A according to the above-mentioned expression (3).

As shown in FIG. 6, the amplitude F(z) of refractive index modulation is positive and negative when the vibration amplitude a of the phase grating mask 200 falls within the range of 0 to Λ/4 and within the range of Λ/4 to 3Λ/4, respectively. Namely, if the vibration amplitude a of the phase grating mask 200 is Λ/4 at a certain position z₀ and changes from less than Λ/4 to more than Λ/4 (or vice versa) across this position z₀, the amplitude F(z) of refractive index modulation attains a phase inverting part at the position z₀ (see FIGS. 7A and 7B).

For obtaining such a refractive index modulation amplitude F(z), the optical system 323 is used such that the refractive index modulation inducing light UV incident on the phase grating mask 200 preferably attains a luminous flux width of 500 μm or less (more preferably 100 μm or less) in the z-axis direction. Preferably, the mirror 324 is moved at a constant speed in the z-axis direction. As the mirror 324 moves at a constant speed (i.e., the irradiation position z of refractive index modulation inducing light UV is scanned), the phase grating mask 200 vibrates along the z axis with a vibration amplitude a(z) according to the irradiation position z. If the intensity of refractive index modulation inducing light UV and the scanning speed of its irradiation position z are constant, the average effective refractive index of the optical fiber 110 in the refractive index modulation forming area becomes uniform along the z axis.

Further, as explained with reference to FIGS. 3A to 3D, 4A to 4C, and 5, the irradiation position of the refractive index change inducing light UV is repeatedly scanned in the longitudinal direction while the phase or period of vibration of the phase grating mask 200 is changed for each scan. Alternatively, the irradiation position of the refractive index change inducing light UV is scanned in the longitudinal direction while the period of vibration of the phase grating mask 200 is changed upon scanning. As such, the diffraction grating device 100 having desirable reflection characteristics can easily be made.

The foregoing explanations assume an ideal case where the waveform of vibration of the phase grating mask 200 is a square wave as shown in FIG. 8A whereas each of the respective probabilities of displacement being +a and −a is ½. In practice, however, it takes a certain fixed time ΔT (e.g., several milliseconds to several tens of milliseconds) for the waveform to shift from one end (where the displacement is +a) to the other end (where the displacement is −a) and vice versa as shown in FIG. 8B. If this transition time ΔT is not negligible, the refractive index modulation formed according to the above-mentioned expression (3) may become inaccurate. Therefore, as shown in FIG. 8C, the shutter 322 is closed during the above-mentioned transition time ΔT in which the phase grating mask 200 is in a transitional state of movement upon vibration, so that the optical fiber 110 is not irradiated with the refractive index modulation inducing light UV. Alternatively, the period T of vibration of the phase grating mask 200 is made so as to become at least 20 times the above-mentioned transition time ΔT, so that the transition time ΔT is shorter than the period T to such an extent that it is negligible. This can accurately adjust the refractive index modulation amplitude F(z).

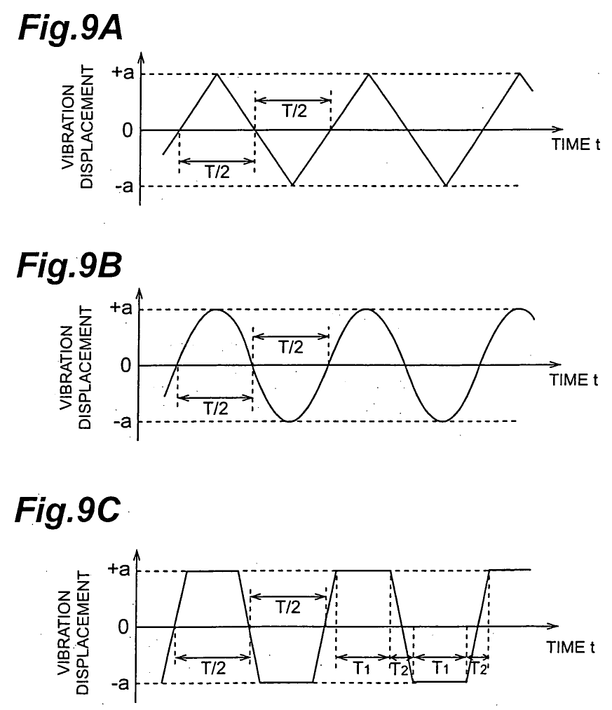

The waveforms shown in FIGS. 9A to 9C are also preferable as the vibration of the phase grating mask 200. When the vibration of the phase grating mask 200 has a triangular waveform as shown in FIG. 9A, the diffraction grating 113 formed in the optical fiber 110 has a refractive index distribution n(z) represented by the following expression (4):

$$\begin{matrix}n ( z ) = {n}_{0} + {α}_{1} {\int }_{- T / 4}^{T / 4} cos ( \frac{2 π}{Λ} ( z - \frac{4 α}{T} t ) ) ⅆ t \\ = {n}_{0} + {F}_{1} ( z ) \cdot cos ( \frac{2 π}{Λ} z )\end{matrix} \qquad ( 4 )$$

whereas the amplitude distribution F₁(z) of refractive index modulation is represented by the following expression (5)

$${F}_{1} ( z ) = Δ {n}_{1} \frac{Λ}{a} sin ( \frac{2 π}{Λ} a ) \qquad ( 5 )$$

where α₁ and Δn₁ are fixed coefficients.

When the vibration of the phase grating mask 200 has a sinusoidal waveform as shown in FIG. 9B, the diffraction grating 113 formed in the optical fiber 110 has a refractive index distribution n(z) represented by the following expression (6):

$$\begin{matrix}n ( z ) = {n}_{0} + {α}_{2} {\int }_{- T / 2}^{T / 2} cos ( \frac{2 π}{Λ} [ z - a \cdot sin ( \frac{2 π}{T} t ) ] ) ⅆ t \\ = {n}_{0} + {F}_{2} ( z ) \cdot cos ( \frac{2 π}{Λ} z )\end{matrix} \qquad ( 6 )$$

whereas the amplitude distribution F₂(z) of refractive index modulation is represented by the following expression (7):

$${F}_{2} ( z ) = Δ {n}_{2} {\int }_{0}^{T / 2} cos ( \frac{2 π}{Λ} a \cdot sin ( \frac{2 π}{T} t ) ) ⅆ t \qquad ( 7 )$$

where α₂ and Δn₂ are fixed coefficients.

When the vibration of the phase grating mask 200 has a trapezoidal waveform as shown in FIG. 9C, the amplitude distribution of refractive index modulation is represented by an expression obtained as a weighted mean of the above-mentioned expressions (3) and (5) which is in conformity to the ratio between the time T₁ in which the displacement is at the position +a or −a and the transition time T₂ between these two positions.

Thus, when the vibration of the phase grating mask 200 has a fixed waveform, the refractive index modulation amplitude F(z) conforms to the amplitude a of vibration of the phase grating mask 200 at each position z. Namely, when the amplitude a of vibration of the phase grating mask 200 is controlled according to each position z, the refractive index modulation amplitude F(z) is adjusted.

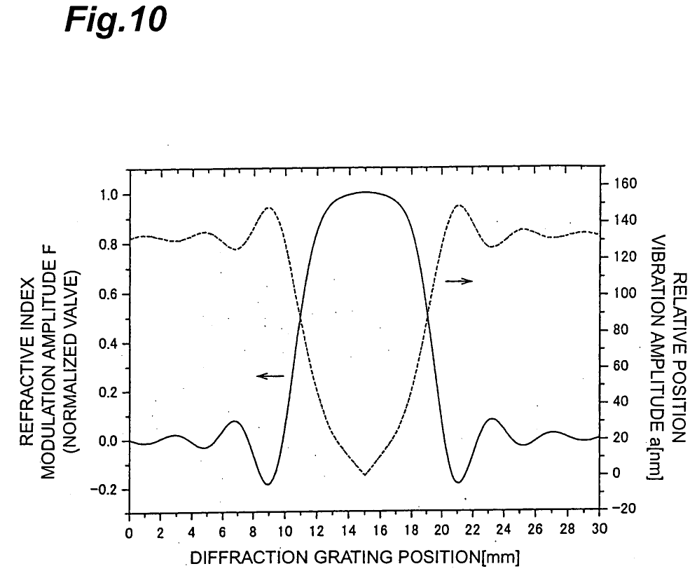

In order for the refractive index modulation amplitude F(z) to be a function of position z, it will be preferred if the luminous flux width 2w of refractive index modulation inducing light UV in the z-axis direction is smaller. Hence, the relationship between the luminous flux width 2w of refractive index modulation inducing light UV and the actually realized refractive index modulation amplitude will now be explained. Here, it is assumed that the vibration of the phase grating mask 200 has a square waveform, the scanning speed of the irradiation position of refractive index modulation inducing light UV is constant, and the intensity of refractive index modulation inducing light UV is uniform within the luminous flux width 2w. Suppose a case where the phase grating mask 200 vibrates in conformity to the vibration amplitude a(z) indicated by the broken line in FIG. 10 so as to form the refractive index modulation amplitude distribution F(z) indicated by the solid line in the same graph. The vibration amplitude a(z) of the phase grating mask 200 is obtained according to the above-mentioned expression (3).

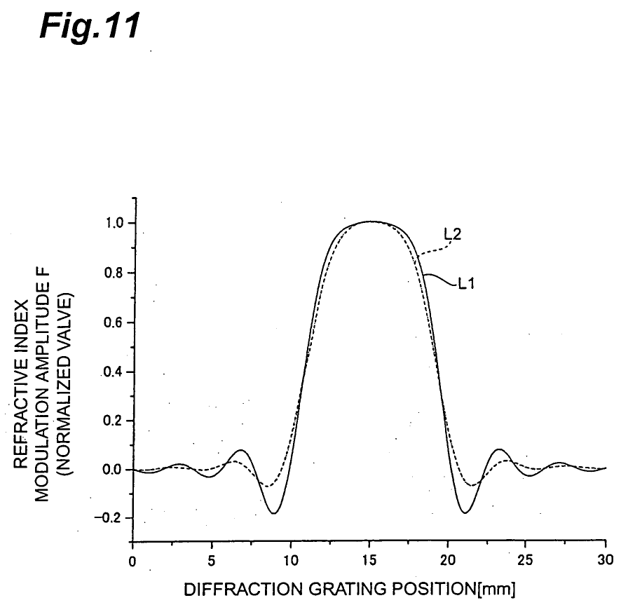

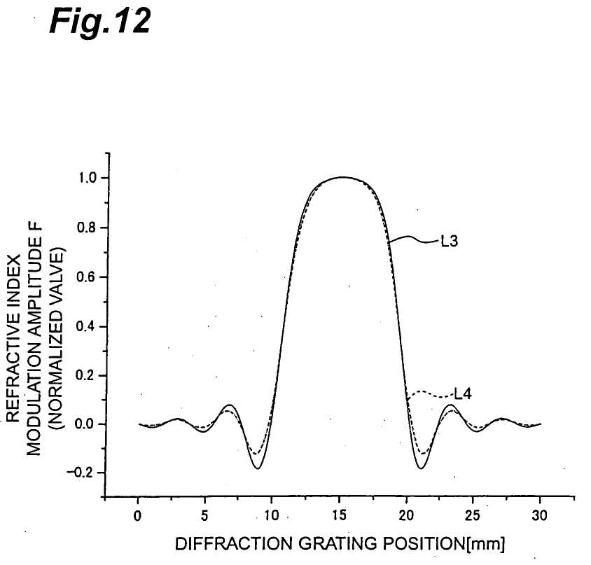

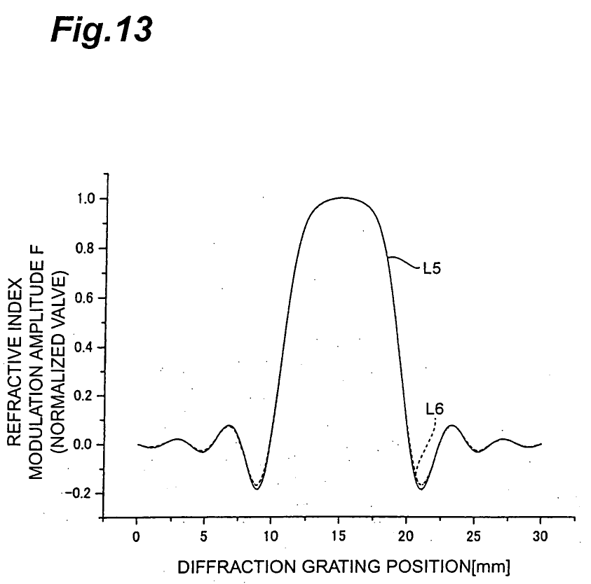

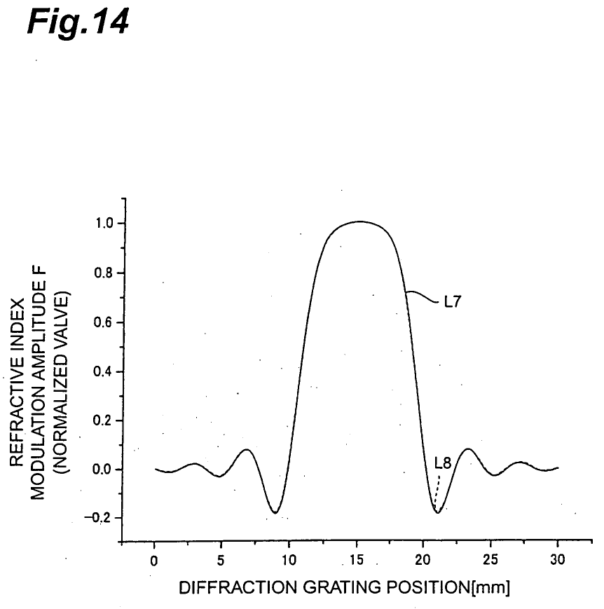

The position z is irradiated with the refractive index modulation inducing light UV during a period in which the center irradiation position of refractive index modulation inducing light UV moves from z−w to z+w. Therefore, during when the center irradiation position of refractive index modulation inducing light UV moves from z−w to z+w, the refractive index modulation amplitude actually realized at each position z is under the influence of the vibration amplitude a(z) of the phase grating mask 200. Namely, the refractive index modulation amplitude realized depends on the luminous flux width 2w of refractive index modulation inducing light UV. FIG. 11 is a graph showing a designed value of refractive index modulation amplitude (solid line L1) and the refractive index modulation amplitude (solid line L2) obtained when the luminous flux width 2w is 3 mm. FIG. 12 is a graph showing a designed value of refractive index modulation amplitude (solid line L3) and the refractive index modulation amplitude (solid line L4) obtained when the luminous flux width 2w is 2 mm. FIG. 13 is a graph showing a designed value of refractive index modulation amplitude (solid line L5) and the refractive index modulation amplitude (solid line L6) obtained when the luminous flux width 2w is 1 mm. FIG. 14 is a graph showing a designed value of refractive index modulation amplitude (solid line L7) and the refractive index modulation amplitude (solid line L8) obtained when the luminous flux width 2w is 0.5 mm. As can be seen from these graphs, the difference between the refractive index modulation amplitude realized and the designed value becomes smaller as the luminous flux width 2w of refractive index modulation inducing light UV decreases. When the luminous flux width 2w of refractive index modulation inducing light UV is 0.5 mm or less, the difference between the refractive index modulation amplitude realized and the designed value is so small that it is negligible.

Thus, the refractive index modulation amplitude realized becomes closer to the designed value as the luminous flux width 2w of refractive index modulation inducing light UV is smaller. If the density of intensity of refractive index modulation inducing light UV is constant, however, the irradiation time of refractive index modulation inducing light UV at each position will become shorter as the luminous flux width 2w of refractive index modulation inducing light UV is smaller, thus yielding a smaller amount of irradiation. As a consequence, the irradiation position scanning speed is required to slow down, whereby it takes a longer time to make the diffraction grating device 100.

Therefore, a technique by which the refractive index modulation amplitude realized can be made closer to the designed value even when the luminous flux width 2w of refractive index modulation inducing light UV is large will now be explained. Here, it is assumed that the scanning speed of irradiation position of the refractive index modulation inducing light UV is constant, whereas the intensity of refractive index modulation inducing light UV is uniform within the luminous flux width 2w. Let the following relational expression (8):

f=G(a) (8)

hold between the vibration amplitude a of the phase grating mask 200 and the refractive index modulation amplitude f in an ideal case where the luminous flux width 2w is very small. In this case, the refractive index modulation amplitude F(z) realized at each position z is represented by the following expression (9):

F(z)=c∫_{z-w}^{z+w}f(z₁)dz₁=C∫_{z-w}^{z+w}G(a(z₁))dz₁ (9)

where C is a constant.

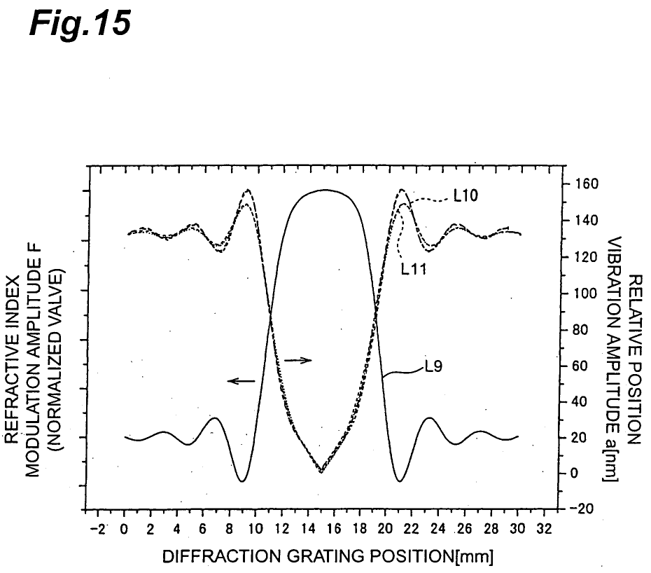

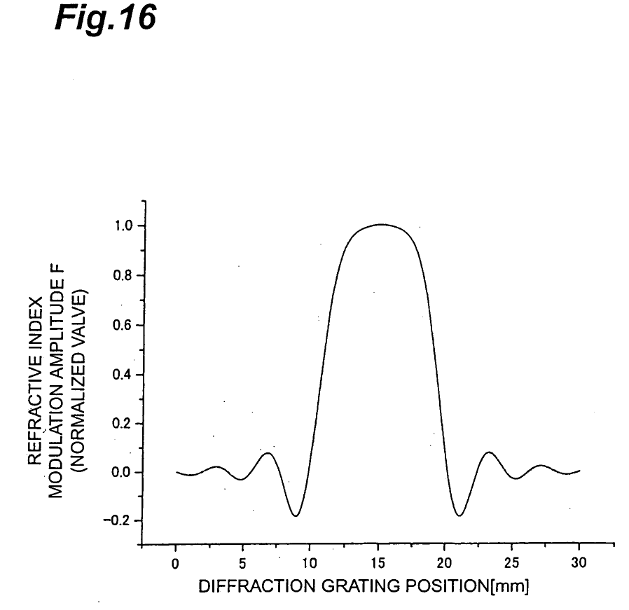

Then, the vibration amplitude a(z) of the phase grating mask 200 is appropriately designed such that the refractive index modulation amplitude F(z) represented by expression (9) attains a designed value. When the vibration amplitude a(z) of the phase grating mask 200 is designed as such, the refractive index modulation amplitude realized approaches the designed value. FIG. 15 is a graph showing a designed value of refractive index modulation amplitude distribution (solid line L9), the vibration amplitude (broken line L10) obtained according to the above-mentioned expression (9), and the vibration amplitude (broken line L11) obtained without regard to the above-mentioned expression (9). FIG. 16 is a graph showing the refractive index modulation amplitude realized when the phase grating mask 200 vibrates in conformity to the vibration amplitude obtained according to the above-mentioned expression (9). Here, the luminous flux width 2w of refractive index modulation inducing light UV was 2 mm. FIG. 12 shows the refractive index modulation amplitude realized when the phase grating mask 200 vibrates in conformity to the vibration amplitude obtained without regard to the above-mentioned expression (9). As can be seen when FIGS. 12 and 16 are compared with each other, the refractive index modulation amplitude realized when the phase grating mask 200 vibrates in conformity to the vibration amplitude obtained according to the above-mentioned expression (9) is closer to the designed value.

In the foregoing explanation, the intensity of refractive index modulation inducing light UV is assumed to be uniform within the luminous flux width 2w. In practice, however, the intensity of refractive index modulation inducing light UV is not uniform but has a certain distribution (e.g., Gaussian distribution). Therefore, a case where the intensity of refractive index modulation inducing light UV has a distribution within the luminous flux width 2w will now be explained. Suppose that the intensity distribution of refractive index modulation inducing light UV within the luminous flux width 2w is represented by P(z₁) with respect to the distance z₁ from the center irradiation position along the z axis. The refractive index modulation amplitude F(z) realized at each position z is represented by the following expression (10):

F(z)=C∫_{z-w}^{z+w}P(z−z₁)G(a(z₁))dz₁ (10)

Then, the vibration amplitude a(z) of the phase grating mask 200 is appropriately set such that the refractive index modulation amplitude F(z) represented by expression (10) attains a designed value. When the vibration amplitude a(z) of the phase grating mask 200 is designed as such, the refractive index modulation amplitude realized approaches the designed value.

The embodiment explained in the foregoing controls the refractive index modulation amplitude by regulating the waveform (amplitude in particular) of relative vibration of the phase grating mask 200 with reference to the optical fiber 110. However, the refractive index modulation amplitude may be controlled by regulating the duty cycle of relative vibration of the phase grating mask 200 instead of the amplitude. A case regulating the duty cycle of relative vibration of the phase grating mask 200 will now be explained. This is also realized by the diffraction grating device 300 in accordance with this embodiment or the diffraction grating device making method in accordance with the embodiment.

At a certain irradiation position z, a state 1 where the phase grating mask 200 is displaced by +Λ/4 and a state 2 where the phase grating mask 200 is displaced by −Λ/4 are assumed. The refractive index modulation Δn₁(z) formed in the optical fiber 110 in the state 1 is represented by the expression of

$$Δ {n}_{1} ( z ) = Δ {n}_{0} \cdot cos ( \frac{2 π}{Λ} ( z - \frac{Λ}{4} ) ) = Δ {n}_{0} \cdot sin ( \frac{2 π}{Λ} z ) , \qquad ( 11 )$$

whereas the refractive index modulation Δn₂(z) formed in the optical fiber 110 in the state 2 is represented by the expression of

$$Δ {n}_{2} ( z ) = Δ {n}_{0} \cdot cos ( \frac{2 π}{Λ} ( z + \frac{Λ}{4} ) ) = - Δ {n}_{0} \cdot sin ( \frac{2 π}{Λ} z ) . \qquad ( 12 )$$

Here, only the modulation component is considered. The above-mentioned expressions (11) and (12) differ from each other only in their polarities.

Also, it is assumed that the states 1 and 2 hold during times t₁ and t₂ in the vibration period T of the phase grating mask 200, respectively. In this case, the refractive index modulation Δn(z) formed in the optical fiber 110 is represented by the expression of

$$\begin{matrix}Δ n ( z ) = \frac{{t}_{1}}{T} Δ {n}_{1} ( z ) + \frac{{t}_{2}}{T} Δ {n}_{2} ( z ) \\ = \frac{{t}_{1} - {t}_{2}}{T} Δ {n}_{0} \cdot sin ( \frac{2 π}{Λ} z ) \\ = ( \frac{2 {t}_{1}}{T} - 1 ) Δ {n}_{0} \cdot sin ( \frac{2 π}{Λ} z ) .\end{matrix} \qquad ( 13 )$$

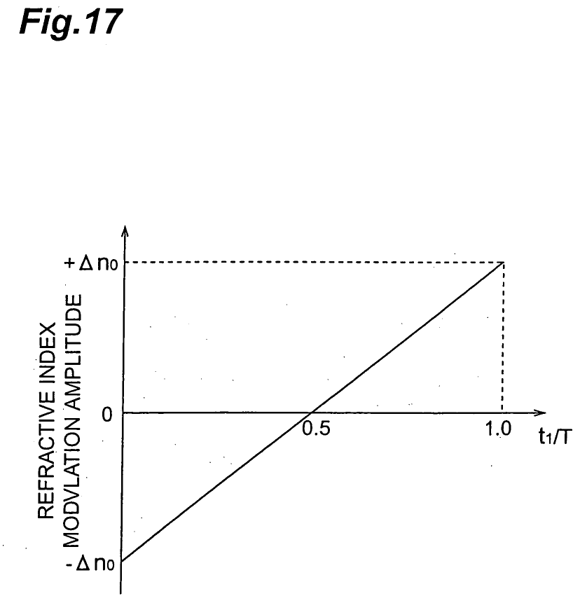

Here, Δn₀ represents the refractive index modulation amplitude when the state 1 always holds (t₁=T). As can be seen from the above-mentioned expression (13), the amplitude of refractive index modulation Δn(z) is represented by the expression of (t₁−t₂)Δn₀/T, and has a linear relationship with the duty cycle (t₁/T) of relative vibration of the phase grating mask 200 as shown in FIG. 17. The refractive index modulation amplitude attains the maximum value (Δn₀) and minimum value (−Δn₀) when t₁=T and t₁=0, respectively. The refractive index modulation amplitude is positive, 0, and negative when t₁>t₂ (i.e., t₁>T/2), t₁=t₂ (i.e., t₁=T/2), and t₁<t₂ (i.e., t₁<T/2), respectively.

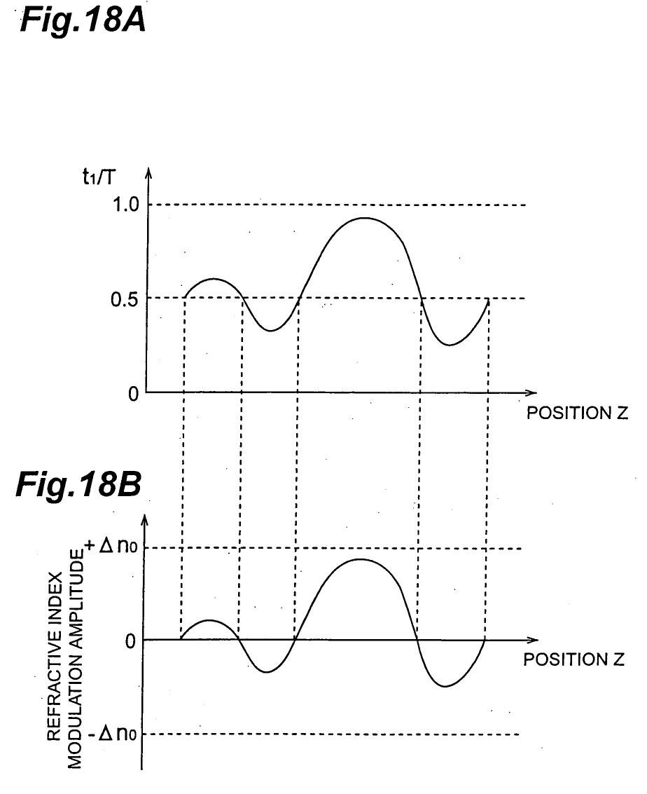

Therefore, scanning the irradiation position z while regulating the ratio between the times t₁ and t₂ (i.e., duty cycle t₁/T) in vibration of the phase grating mask 200 according to the irradiation position z can control the amplitude distribution of refractive index modulation. Reversing the magnitude relationship between the times t₁ and t₂ (i.e., magnitude relationship between the duty cycle (t₁/T) and value ½) at a certain position in the process of scanning can realize the diffraction grating device 100 in which the amplitude distribution of refractive index modulation has a phase inverting part. For yielding the refractive index modulation amplitude shown in FIG. 18B, it will be sufficient if the duty cycle (t₁/T) of vibration of the phase grating mask 200 at each position z is regulated as shown in FIG. 18A.

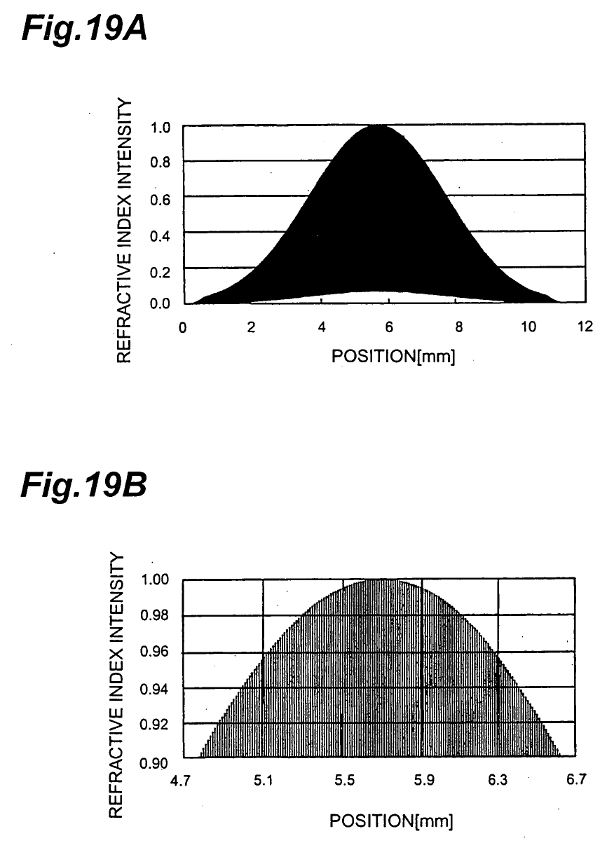

Examples of the diffraction grating device making method in accordance with this embodiment will now be explained together with comparative examples. FIGS. 19A and 19B are charts showing the refractive index modulation in each of diffraction grating devices in accordance with examples and comparative examples. FIG. 19B enlarges a part of FIG. 19A. The refractive index modulation amplitude distribution has an apodized form as shown in these charts.

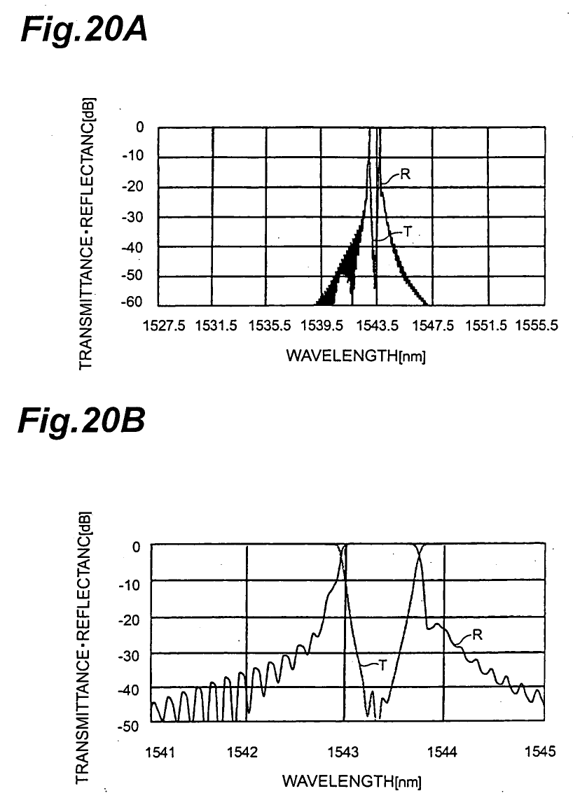

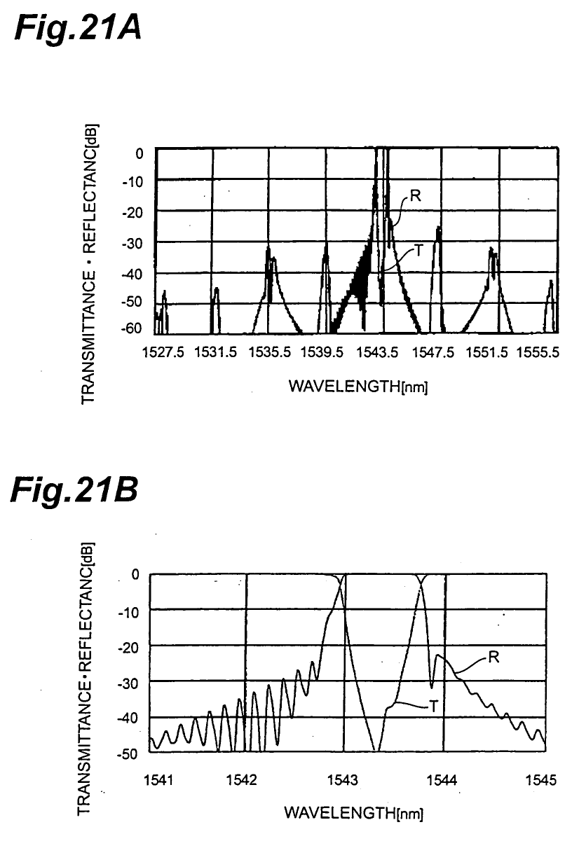

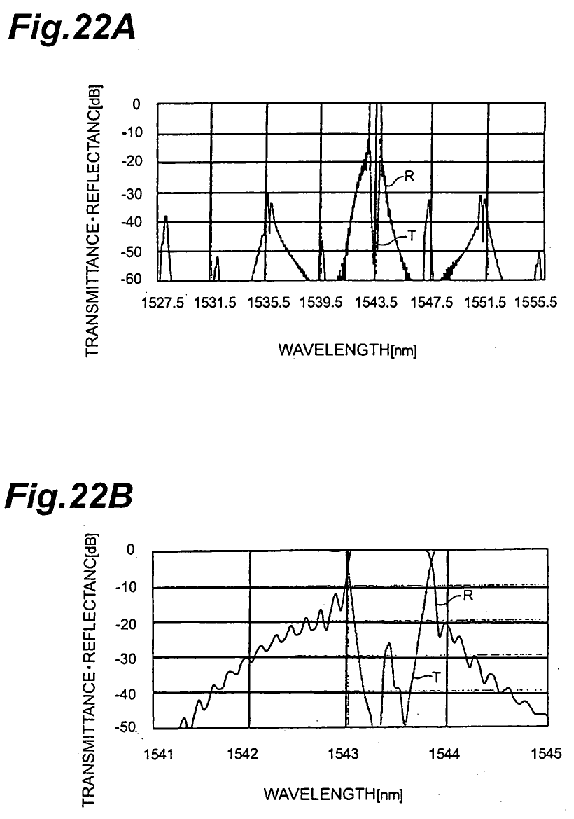

FIGS. 20A and 20B are charts showing reflection characteristics R and transmission characteristics T of the diffraction grating device in accordance with a first comparative example. FIGS. 21A and 21B are charts showing reflection characteristics R and transmission characteristics T of the diffraction grating device in accordance with a second comparative example. FIGS. 22A and 22B are charts showing reflection characteristics R and transmission characteristics T of the diffraction grating device in accordance with a third comparative example. FIGS. 20B, 21B, and 22B partly enlarge FIGS. 20A, 21A, and 22A, respectively. The diffraction grating device in accordance with the first comparative example was made by using refractive index change inducing light having a luminous flux width 2w of 0.2 mm without vibrating a phase grating mask. The diffraction grating device in accordance with the second comparative example was made by using refractive index change inducing light having a luminous flux width 2w of 0.2 mm while vibrating the phase grating mask. The diffraction grating device in accordance with the third comparative example was made by using refractive index change inducing light having a luminous flux width 2w of 0.6 mm while vibrating the phase grating mask. In each of the second and third comparative examples, the amplitude of vibration of the phase grating mask was 212 μm, and the phase and period of vibration were held constant.

As can be seen from comparison among FIGS. 20A and 20B, 21A and 21B, and 22A and 22B, unintentional reflection peaks appear on both sides of an original reflection band based on the Bragg conditional expression in the case where the phase grating mask is vibrated (FIGS. 21A and 21B) as compared with the case where the phase grating mask is not vibrated (FIGS. 20A and 20B). When the phase grating mask is vibrated, the unintentional reflection peaks are smaller in the case where the luminous flux width 2w of refractive index change inducing light is greater (FIGS. 22A and 22B) than in the case where the luminous flux width 2w of refractive index change inducing light is smaller (FIGS. 21A and 21B). These unintentional reflection peaks seem to occur because of the fact that the phase grating mask vibrates periodically.

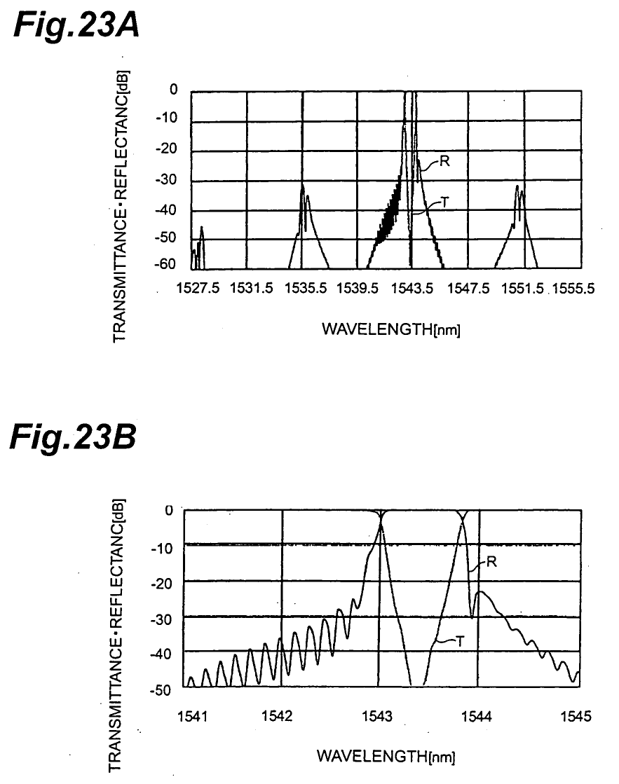

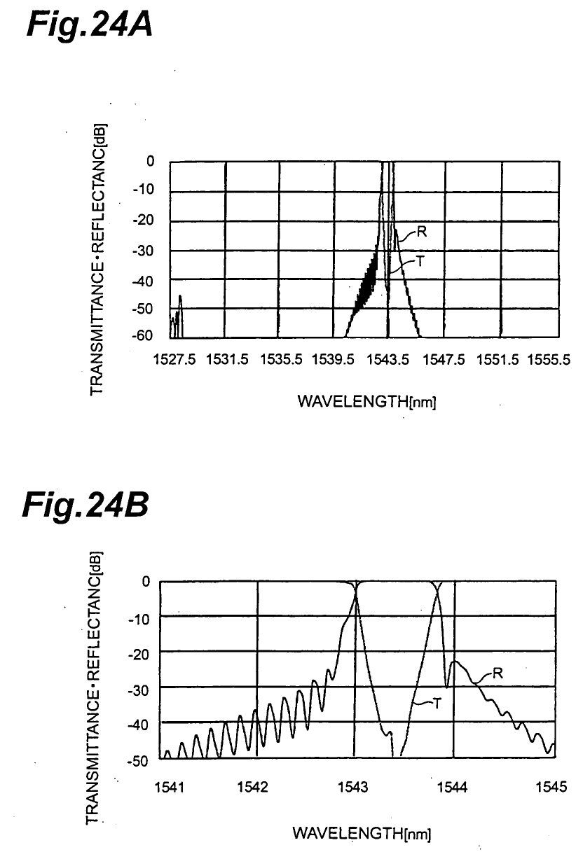

FIGS. 23A and 23B are charts showing reflection characteristics R and transmission characteristics T of the diffraction grating device in accordance with a first example. FIGS. 24A and 24B are charts showing reflection characteristics R and transmission characteristics T of the diffraction grating device in accordance with a second example. FIGS. 23B and 24B partly enlarge FIGS. 23A and 24A, respectively. In each of the first and second examples, while the phase grating mask was vibrated, the irradiation position of refractive index change inducing light having a luminous flux width 2w of 0.2 mm was repeatedly scanned in the longitudinal direction, and the phase of vibration of the phase grating mask was changed for each scan. In the first example, the number of scans was 2, whereas the phase of vibration of the phase grating mask was shifted by n for each scan. In the second example, the number of scans was 4, whereas the phase of vibration of the phase grating mask was shifted by π/2 for each scan.

As can be seen from comparison among FIGS. 21A and 21B, 23A and 23B, and 24A and 24B, when the phase grating mask is vibrated, unintentional reflection peaks appearing on both sides of the original reflection band based on the Bragg conditional expression are smaller in the case where the phase of vibration of the phase grating mask is changed for each scan of refractive index change inducing light (FIGS. 23A and 23B and 24A and 24B) than in the case where the phase and period of vibration of the phase grating mask were held constant (FIGS. 21A and 21B). Also, when the phase of vibration of the phase grating mask is changed for each scan of refractive index change inducing light, the unintentional reflection peaks are smaller in the case of 4 scans (where the phase shifts by π/2; FIGS. 24A and 24B) than in the case of 2 scans (where the phase shifts by n; FIGS. 23A and 23B).

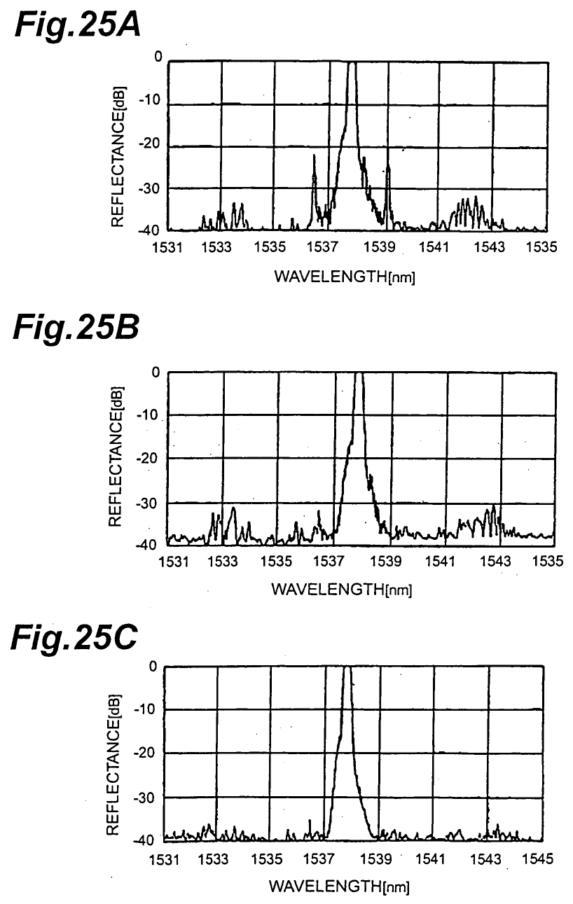

FIGS. 25A to 25C are charts showing reflection characteristics of the diffraction grating devices in accordance with the second comparative example, first example, and second example. While FIGS. 20A and 20B to 24A and 24B show results of simulations, FIGS. 25A to 25C show results of experiments. FIGS. 25A, 25B, and 25C correspond to the second comparative example, first example, and second example, respectively. In each case, the period of vibration of the phase grating mask was set to 600 μm. FIGS. 25A to 25C are seen to show substantially the same results as those of FIGS. 21A and 21B, 23A and 23B, and 24A and 24B.

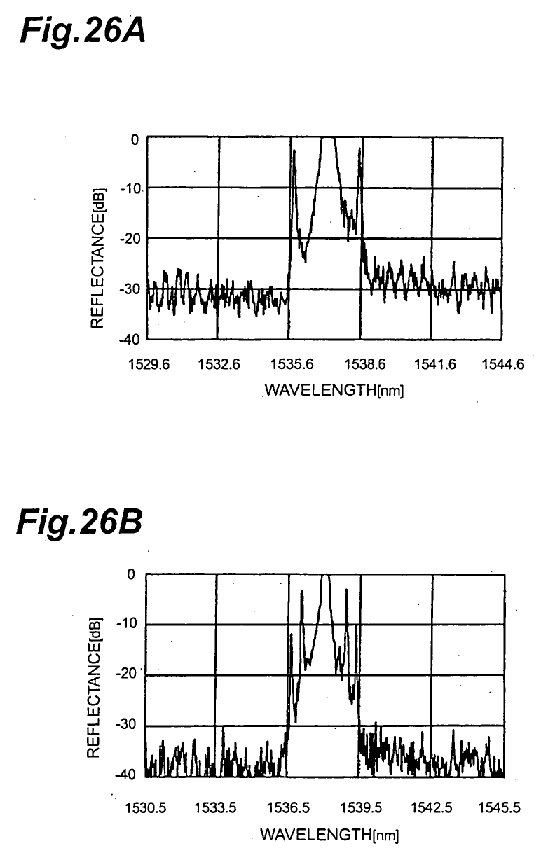

FIGS. 26A and 26B show reflection characteristics of diffraction grating devices in accordance with a fourth comparative example and a third example. FIG. 26A shows reflection characteristics of the diffraction grating device in accordance with the fourth comparative example, whereas FIG. 26B shows reflection characteristics of the diffraction grating device in accordance with the third example. In the fourth comparative example, the period of vibration of the phase grating mask was set to a fixed value of 600 μm. In the third example, the period of vibration of the phase grating mask was set to 600 μm in the first scan, and 900 μm in the second scan. As can be seen from these charts, large reflection peaks appear at wavelengths shifted by ±1.3 nm from the original reflection band in the fourth comparative example but are suppressed in the third example.

As in the foregoing, this embodiment can make a diffraction grating device having excellent reflection characteristics by repeatedly scanning the irradiation position of refractive index change inducing light in the longitudinal direction while changing the phase or period of vibration of the phase grating mask for each scan. A diffraction grating device having excellent reflection characteristics can also be made when the controller 340 scans the irradiation position of refractive index change inducing light while changing the period of vibration of the phase grating mask upon scanning.

Embodiments of an optical add/drop module equipped with the diffraction grating device in accordance with the above-mentioned embodiment will now be explained. The diffraction grating device included in the add/drop module of each of the embodiments explained in the following is the diffraction grating device 100 in accordance with the above-mentioned embodiment, having a phase inverting part, and can selectively reflect a multitude of wavelengths of light. In the following, the diffraction grating device 100 is assumed to reflect wavelengths λ₂ₘ of light but transmit wavelengths λ₂ₘ₊₁ of light therethrough. Here, m is an integer of at least 1 but not greater than M, whereas M is an integer of at least 2, and each wavelength satisfies the following relational expression (14):

λ₁<λ₂<λ₃< . . . <λ_{2M-1}<λ_{2M} (14)

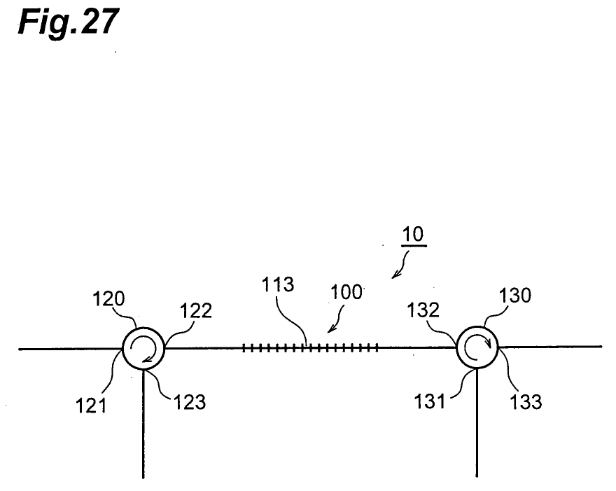

FIG. 27 is an explanatory view of a first add/drop module 10. This add/drop module 10 is constituted such that an optical circulator 120 is connected to one end of the diffraction grating device 100 whereas an optical circulator 130 is connected to the other end of the diffraction grating device 100. The optical circulator 120 has a first terminal 121, a second terminal 122, and a third terminal 123. Light inputted to the first terminal 121 is outputted from the second terminal 122 to the diffraction grating device 100, whereas light inputted to the second terminal 122 is outputted from the third terminal 123. The optical circulator 130 has a first terminal 131, a second terminal 132, and a third terminal 133. Light inputted to the first terminal 131 is outputted from the second terminal 132 to the diffraction grating device 100, whereas light inputted to the second terminal 132 is outputted from the third terminal 133.

When wavelengths λ₂ₘ₊₁ of light are inputted to the first terminal 121 of the optical circulator 120, these wavelengths λ₂ₘ₊₁ of light are outputted from the second terminal 122 of the optical circulator 120 to the diffraction grating device 100, and then are transmitted through the diffraction grating device 100, so as to be inputted to the second terminal 132 of the optical circulator 130 and then outputted from the third terminal 133 thereof. When wavelengths λ₂ₘ of light are inputted to the first terminal 131 of the optical circulator 130, these wavelengths λ₂ₘ of light are outputted from the second terminal 132 of the optical circulator 130 to the diffraction grating device 100, and then are reflected by the diffraction grating device 100, so as to be inputted to the second terminal 132 of the optical circulator 130 and then outputted from the third terminal 133 thereof. Namely, in this case, the add/drop module 10 acts as a multiplexer, so as to multiplex the wavelengths λ₂ₘ₊₁ of light inputted to the first terminal 121 of the optical circulator 120 and the wavelengths λ₂ₘ of light inputted to the first terminal 131 of the optical circulator 130, and output thus multiplexed wavelengths λ₁ to λ_{2M} of light from the third terminal 133 of the optical circulator 130. When the add/drop module 10 is used only as a multiplexer, the optical circulator 120 is unnecessary.

When wavelengths λ₁ to λ_{2M} of light are inputted to the first terminal 121 of the optical circulator 120, these wavelengths of light are outputted from the second terminal 122 of the optical circulator 120 to the diffraction grating device 100. Among these wavelengths, the wavelengths λ₂ₘ of light are reflected by the diffraction grating device 100, so as to be inputted to the second terminal 122 of the optical circulator 120 and then outputted from the third terminal 123 thereof. On the other hand, the wavelengths λ₂ₘ₊₁ of light are transmitted through the diffraction grating device 100, so as to be inputted to the second terminal 132 of the optical circulator 130 and then outputted from the third terminal 133 thereof. Namely, in this case, the add/drop module 10 acts as a demultiplexer, so as to demultiplex wavelengths λ₁ to λ_{2M} and output wavelengths λ₂ₘ of light from the third terminal 123 of the optical circulator 120 and wavelengths λ₂ₘ₊₁ of light from the third terminal 133 of the optical circulator 130. When the add/drop module 10 is used only as a demultiplexer, the optical circulator 130 is unnecessary.

The add/drop module 10 acts as a multiplexer and a demultiplexer, thus acting as an optical ADM (Add/Drop Multiplexer) as well. Namely, the add/drop module 10 outputs (drops) from the third terminal 123 of the optical circulator 120 wavelengths λ₂ₘ of light among the wavelengths λ₁ to λ_{2M} inputted to the first terminal 121 of the optical circulator 120, and inputs (adds) wavelengths λ₂ₘ of light carrying other information from the first terminal 131 of the optical circulator 130. Then, the add/drop module 10 multiplexes the wavelengths λ₂ₘ₊₁ of light among the wavelengths λ₁ to λ_{2M} inputted to the first terminal 121 of the optical circulator 120, and the wavelengths λ₂ₘ of light inputted to the third terminal 131 of the optical circulator 130, and outputs thus multiplexed wavelengths λ₁ to λ_{2M} from the third terminal 133 of the optical circulator 130.

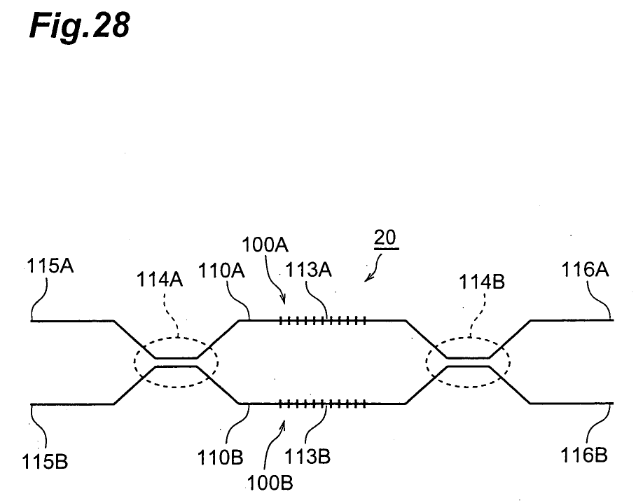

FIG. 28 is an explanatory view of a second add/drop module 20. In this add/drop module 20, optical fibers 110A and 110B are optically coupled to each other by way of optical couplers 114A and 114B. A diffraction grating 113A is formed in a predetermined area of the optical fiber 110A between the optical couplers 114A and 114B, so as to yield a diffraction grating device 100A. On the other hand, a diffraction grating 113B is formed in a predetermined area of the optical fiber 110B between the optical couplers 114A and 114B, so as to yield a diffraction grating device 100B. Each of the diffraction grating devices 100A and 100B is equivalent to the diffraction grating device 100 mentioned above.

When wavelengths λ₂ₘ₊₁ of light are inputted to a first end 115A of the optical fiber 110A in the add/drop module 20, these wavelengths of light are split by the optical coupler 114A, and thus split components are reflected by their corresponding diffraction grating devices 10A, 100B and then are combined by the optical coupler 114B, so as to be outputted from a second end 116A of the optical fiber 110A. When wavelengths λ₂ₘ of light are inputted to a second end 116B of the optical fiber 110B, these wavelengths of light are split by the optical coupler 114B, and thus split components are transmitted through their corresponding diffraction grating devices 100A, 100B and then are combined by the optical coupler 114B, so as to be outputted from the second end 116A of the optical fiber 110A. Namely, in this case, the add/drop module 20 acts as a multiplexer, so as to multiplex the wavelengths λ₂ₘ₊₁ of light inputted to the first end 115A of the optical fiber 110A and the wavelengths λ₂, of light inputted to the second end 116B of the optical fiber 10B, and output thus multiplexed wavelengths λ₁ to λ_{2M} of light from the second end 116A of the optical fiber 110A.

When wavelengths λ₁ to λ_{2M} of light are inputted to the first end 115A of the optical fiber 110A in the add/drop module 20, these wavelengths of light are split by the optical coupler 114A, and thus split components are outputted to their corresponding diffraction grating devices 100A, 100B. Among these wavelengths of light, wavelengths λ₂ₘ of light are reflected by the diffraction grating devices 100A, 100B and then are multiplexed by the optical coupler 114A, so as to be outputted from a first end 115B of the optical fiber 110B. On the other hand, wavelengths λ₂ₘ₊₁ of light are transmitted though the diffraction grating devices 100A, 100B and then are multiplexed by the optical coupler 114B, so as to be outputted from the second end 116A of the optical fiber 110A. Namely, in this case, the add/drop module 20 acts as a demultiplexer, so as to demultiplex wavelengths λ₁ to λ_{2M} of light inputted to the first end 115A of the optical fiber 110A and output the wavelengths λ₂ₘ of light from the first end 115B of the optical fiber 110B and the wavelengths λ₂ₘ₊₁ of light from the second end 116A of the optical fiber 110A.

The add/drop module 20 acts as a multiplexer and a demultiplexer, thereby acting as an optical ADM as well. Namely, the add/drop module 20 outputs (drops) from the first end 115B of the optical fiber 110B wavelengths λ₂ₘ of light among the wavelengths λ₁ to λ_{2M} of light inputted to the first end 115A of the optical fiber 110A, and inputs (adds) wavelengths λ₂ₘ of light carrying other information from the second terminal 116B of the optical fiber 110B. Then, the optical add/drop module 20 multiplexes wavelengths λ₂ₘ₊₁ of light among the wavelengths λ₁ to λ_{2M} of light inputted to the first end 115A of the optical fiber 11A, and the wavelengths λ₂ₘ of light inputted to the second terminal 116B of the optical fiber 110B, and outputs thus multiplexed wavelengths λ₁ to λ_{2M} of light from the second end 116A of the optical fiber 110A.

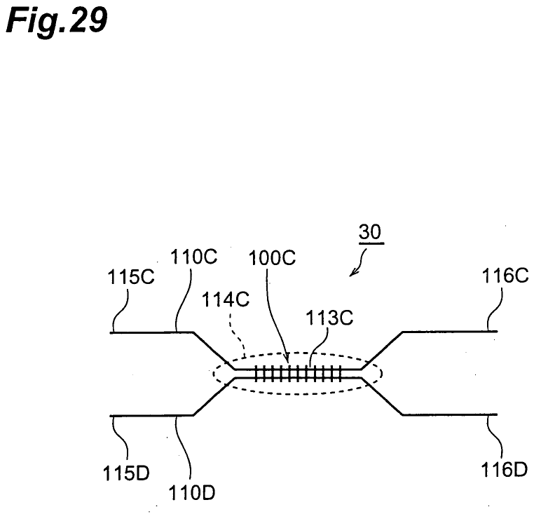

FIG. 29 is an explanatory view of a third add/drop module 30. In this add/drop module 30, optical fibers 110C and 110D are optically coupled to each other by way of an optical coupler 114C, whereas a diffraction grating 113C is formed in a predetermined area of the fused part between the optical fibers 110C and 110D in the optical coupler 114C, so as to yield a diffraction grating device 100C. This diffraction grating device 100C is equivalent to the diffraction grating device 100 mentioned above. Here, the diffraction grating 113C is formed in each of the respective core regions of the optical fibers 110C and 110D.

When wavelengths λ₂ₘ₊₁ of light are inputted to a first end 115C of the optical fiber 110C in this add/drop module 30, these wavelengths of light are transmitted through the diffraction grating device 100C, so as to be outputted from a second end 116C of the optical fiber 110C. When wavelengths λ₂ₘ of light are inputted to a second end 116D of the optical fiber 11D, these wavelengths of light are reflected by the diffraction grating device 100C, so as to be outputted from the second end 116C of the optical fiber 110C. Namely, in this case, the add/drop module 30 acts as a multiplexer, so as to multiplex the wavelengths λ₂ₘ₊₁ of light inputted to the first end 115C of the optical fiber 110C and the wavelengths λ₂ₘ of light inputted to the second end 116D of the optical fiber 110D, and output thus multiplexed wavelengths λ₁ to λ_{2M} of light from the second end 116C of the optical fiber 110C.

When the wavelengths λ₁ to λ_{2M} of light are inputted to the first end 115C of the optical fiber 110C in the add/drop module 30, these wavelengths of light reach the diffraction grating device 100C. Among these wavelengths of light, wavelengths λ₂ₘ of light are reflected by the diffraction grating device 100C, so as to be outputted from a first end 115D of the optical fiber 110D. On the other hand, wavelengths λ₂ₘ₊₁ of light are transmitted through the diffraction grating device 100C, so as to be outputted from the second end 116C of the optical fiber 110C. Namely, in this case, the add/drop module 30 acts as a demultiplexer, so as to demultiplex wavelengths λ₁ to λ_{2M} inputted to the first end 115C of the optical fiber 110C, and output wavelengths λ₂, of light from the first end 115D of the optical fiber 110D and wavelengths λ₂ₘ₊₁ of light from the second end 116C of the optical fiber 110C.

This add/drop module 30 acts as a multiplexer and a demultiplexer, thereby acting as an optical ADM as well. Namely, the add/drop module 30 outputs (drops) from the first end 115D of the optical fiber 110D wavelengths λ₂ₘ of light among the wavelengths λ₁ to λ_{2M} inputted to the first end 115C of the optical fiber 110C, and inputs (adds) wavelengths λ₂ₘ of light carrying other information from the second end 116D of the optical fiber 110D. Then, the add/drop module 30 multiplexes wavelengths λ₂ₘ₊₁ of light among the wavelengths λ₁ to λ_{2M} inputted to the first end 115C of the optical fiber 110C, and the wavelengths λ₂ₘ of light inputted to the second end 116D of the optical fiber 110D, and outputs thus multiplexed wavelengths λ₁ to λ_{2M} of light from the second end 116C of the optical fiber 110C.

Each of the diffraction grating devices included in the foregoing add/drop modules 10, 20, and 30 is the diffraction grating device 100 in accordance with the above-mentioned embodiment, having a phase inverting part and is excellent in reflecting characteristics. In the diffraction grating device 100, each of the add/drop modules 10, 20, and 30 exhibits a low transmittance within the reflection wavelength band and a low reflectance outside the reflection wavelength band, whereby it is hard to yield crosstalk, and exhibits a low reception error occurrence ratio and a low power loss for wavelengths λ₂ₘ of light even when the difference between the reflection wavelengths λ₂ₘ and transmission wavelengths λ₂ₘ₊₁ is small.

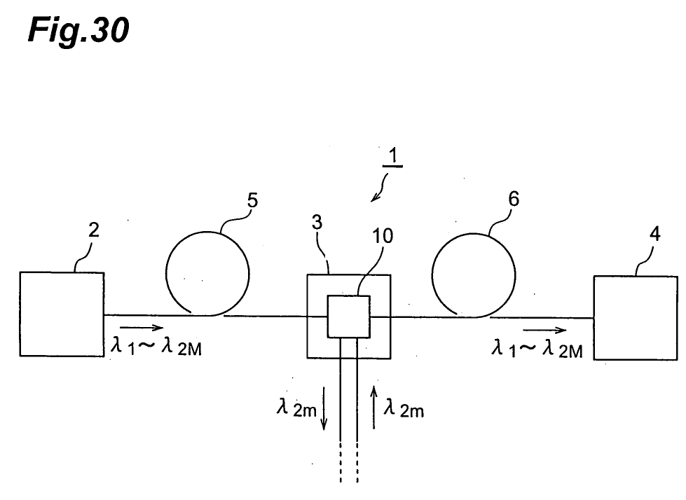

The optical transmission system in accordance with an embodiment will now be explained. FIG. 30 is a schematic diagram of the optical transmission system 1 in accordance with this embodiment. In the optical transmission system 1, a transmitting station 2 and a repeater station 3 are connected to each other by an optical fiber transmission line 5, whereas the repeater station 3 and a receiving station 4 are connected to each other by an optical fiber transmission line 6. The repeater station 3 is provided with an add/drop module 10.

The transmitting station 2 wavelength-multiplexes wavelengths λ₁ to λ_{2M} of signal light, and sends thus multiplexed signal light to the optical fiber transmission line 5. The repeater station 3 inputs the wavelengths λ₁ to λ_{2M} of signal light propagated through the optical fiber transmission line 5, which are then demultiplexed by the add/drop module 10, whereby wavelengths λ₂ₘ₊₁ of signal light are sent to the optical fiber transmission line 6, whereas wavelengths λ₂ₘ of signal light are sent to another optical fiber transmission line. By using the add/drop module 10, the repeater station 3 sends to the optical fiber transmission line 6 wavelengths λ₂ₘ of signal light inputted by way of another optical fiber transmission line. The receiving station 4 inputs wavelengths λ₁ to λ_{2M} of signal light propagated through the optical fiber transmission line 6, demultiplexes them into individual wavelengths, and then receives these individual wavelengths.

The optical transmission system 1 uses the add/drop module 10 including the diffraction grating device 100 in accordance with the above-mentioned embodiment, so as to multiplex or demultiplex wavelengths λ₁ to λ_{2M} of signal light. Therefore, even when the difference between the reflection wavelengths λ₂ₘ and transmission wavelengths λ₂ₘ₊₁ is small in the diffraction grating device 100, crosstalk is hard to occur, reception error occurrence ratio is low, and power loss for reflection wavelengths λ₂ₘ of light is low. Here, the add/drop module 20 or 30 may be provided in place of the add/drop module 10 as well.

Without being restricted to the above-mentioned embodiments, the present invention can be modified in various manners. The diffraction grating device in accordance with the above-mentioned embodiment is one comprising an optical fiber, which is an optical waveguide, having a diffraction grating formed by refractive index modulation. However, this is not restrictive. For example, an optical waveguide formed on a flat substrate may be provided with a diffraction grating formed by refractive index modulation.

In the present invention, as explained in detail in the foregoing, a phase grating mask is disposed beside an optical waveguide and is vibrated in the longitudinal direction relative to the optical waveguide. The optical waveguide is irradiated with the refractive index change inducing light by way of the vibrating phase grating mask. According to intensity patterns of interference fringes generated upon the irradiation, refractive index modulation is caused in the optical waveguide, which forms a diffraction grating, thereby making a diffraction grating device. The amplitude of thus formed refractive index modulation conforms to the waveform of relative vibration of the phase grating mask with respect to the optical waveguide. The irradiation position of refractive index change inducing light is repeatedly scanned in the longitudinal direction, while the phase or period of vibration of the phase grating mask changes for each scan. Alternatively, the irradiation position of refractive index change inducing light is scanned in the longitudinal direction, while the period of vibration of the phase grating mask is changed upon scanning. Thus manufactured diffraction grating device has an amplitude distribution of refractive index appropriately designed along its longitudinal direction. For example, the amplitude distribution of refractive index modulation has a phase inverting part. This allows the diffraction grating device to reflect light having a plurality of wavelengths selectively or suppress its chromatic dispersion, for example.

From the foregoing explanations of the invention, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for making a diffraction grating device having a diffraction grating formed by refractive index modulation over a predetermined area in an optical waveguide along a longitudinal direction thereof;
the method comprising the steps of:
disposing a phase grating mask beside the optical waveguide;
irradiating the optical waveguide with refractive index change inducing light by way of the phase grating mask while repeatedly scanning an irradiation point of the refractive index change inducing light in the longitudinal direction;
vibrating the phase grating mask in the longitudinal direction relative to the optical waveguide upon irradiation with the refractive index change inducing light; and
changing a phase or period of vibration of the phase grating mask for each scan of the irradiation point of the refractive index change inducing light, so as to form a diffraction grating in the optical waveguide.

2. A method according to claim 1, wherein the irradiation position of the refractive index change inducing light is scanned N times, where N is an integer of 2 or greater, while the phase of vibration of the phase grating mask is shifted by 2π/N for each scan.

3. A method according to claim 2, wherein N is a power of 2.

4. A method for making a diffraction grating device having a diffraction grating formed by refractive index modulation over a predetermined area in an optical waveguide along a longitudinal direction thereof;
the method comprising the steps of:
disposing a phase grating mask beside the optical waveguide;
irradiating the optical waveguide with refractive index change inducing light by way of the phase grating mask while scanning an irradiation point of the refractive index change inducing light in the longitudinal direction;
vibrating the phase grating mask in the longitudinal direction relative to the optical waveguide upon irradiation with the refractive index change inducing light; and
changing a phase or period of vibration of the phase grating mask upon scanning the irradiation point of the refractive index change inducing light, so as to form a diffraction grating in the optical waveguide.

5. An apparatus for making a diffraction grating device having a diffraction grating formed by refractive index modulation over a predetermined area in an optical waveguide along a longitudinal direction thereof;
the apparatus comprising:
refractive index change inducing light irradiating means for irradiating the optical waveguide with refractive index change inducing light by way of a phase grating mask disposed beside the optical waveguide, and repeatedly scanning an irradiation position of the refractive index change inducing light in the longitudinal direction; and
phase grating mask vibrating means for vibrating the phase grating mask in the longitudinal direction relative to the optical waveguide upon irradiation with the refractive index change inducing light, and changing a phase or period of vibration of the phase grating mask for each scan of the irradiation point of the refractive index change inducing light.

6. An apparatus according to claim 5, wherein the refractive index change inducing light irradiating means scans the irradiation position of the refractive index change inducing light N times, where N is an integer of 2 or greater; and
wherein the phase grating mask vibrating means shifts the phase of vibration of the phase grating mask by 2π/N for each scan.

7. An apparatus according to claim 6, wherein N is a power of 2.

8. An apparatus for making a diffraction grating device having a diffraction grating formed by refractive index modulation over a predetermined area in an optical waveguide along a longitudinal direction thereof;
the apparatus comprising:
refractive index change inducing light irradiating means for irradiating the optical waveguide with refractive index change inducing light by way of a phase grating mask disposed beside the optical waveguide, and scanning an irradiation position of the refractive index change inducing light in the longitudinal direction; and
phase grating mask vibrating means for vibrating the phase grating mask in the longitudinal direction relative to the optical waveguide upon irradiation with the refractive index change inducing light, and changing a phase or period of vibration of the phase grating mask upon scanning the irradiation point of the refractive index change inducing light.

9. A diffraction grating device made by the method according to claim 1.

10. A multi/demultiplexing module including the diffraction grating device according to claim 9, the diffraction grating device selectively reflecting a light component having a reflection wavelength, so as to multiplex or demultiplex light.

11. An optical transmission system for carrying out optical transmission by using wavelength-multiplexed signal light having a plurality of wavelengths, the optical transmission system including the multi/demultiplexing module according to claim 10, the multi/demultiplexing module multiplexing or demultiplexing the signal light having a plurality of wavelengths.

12. A diffraction grating device made by the method according to claim 4.

13. A multi/demultiplexing module including the diffraction grating device according to claim 12, the diffraction grating device selectively reflecting a light component having a reflection wavelength, so as to multiplex or demultiplex light.

14. An optical transmission system for carrying out optical transmission by using wavelength-multiplexed signal light having a plurality of wavelengths, the optical transmission system including the multi/demultiplexing module according to claim 13, the multi/demultiplexing module multiplexing or demultiplexing the signal light having a plurality of wavelengths.
